(19) United States
(12) Patent Application Publication
(10) Pub. No.: US 2020/0333608 A1
(43) Pub. Date: Oct. 22, 2020

(54) DISPLAY DEVICE, PROGRAM, IMAGE PROCESSING METHOD, DISPLAY SYSTEM, AND MOVING BODY

(71) Applicants: Keita KATAGIRI, Kanagawa (JP); Kenichiroh SAISHO, Tokyo (JP); Hiroshi YAMAGUCHI, Kanagawa (JP); Masato KUSANAGI, Kanagawa (JP); Yuuki SUZUKI, Kanagawa (JP); Kazuhiro TAKAZAWA, Tokyo (JP); Tomoyuki TSUKUDA, Kanagawa (JP)

(72) Inventors: Keita KATAGIRI, Kanagawa (JP); Kenichiroh SAISHO, Tokyo (JP); Hiroshi YAMAGUCHI, Kanagawa (JP); Masato KUSANAGI, Kanagawa (JP); Yuuki SUZUKI, Kanagawa (JP); Kazuhiro TAKAZAWA, Tokyo (JP); Tomoyuki TSUKUDA, Kanagawa (JP)

(21) Appl. No.: 16/754,300

(22) PCT Filed: Oct. 12, 2018
(86) PCT No.: PCT/JP2018/038184

§ 371 Date: Apr. 7, 2020

(30) Foreign Application Priority Data
Oct. 13, 2017 (JP) 2017-199914
Oct. 2, 2018 (JP) 2018-187737

(51) Int. Cl. G02B 27/01; B60K 35/00

(52) U.S. Cl. CPC G02B 27/0179; B60K 35/00; G02B 27/0101; G02B 2027/0183; B60K 2370/349; G02B 2027/014; B60K 2370/1529

(57) ABSTRACT

Disclosed is a display device for displaying a virtual image so as to be visually perceived by an occupant of a moving body through a transparent member. The display device includes an image generator configured to generate an image to be displayed as a virtual image; an orientation information acquisition unit configured to acquire information on an orientation of the moving body; and a display change processor configured to change the display of the virtual image in accordance with the information on the orientation acquired by the orientation information acquisition unit.

### TECHNICAL FIELD

The disclosures discussed herein relate to a display device, a program, an image processing method, a display system, and a moving body.

### BACKGROUND ART

A head-up display (HUD) devices is known in the art, which is configured to project information that supports driving of a driver or the like of a vehicle onto a windshield to form the above information as a virtual image ahead of the driver. Since a virtual image forms an image ahead of the windshield of the vehicle, the driver who is looking at a distance is usually able to visually perceive the information that supports his or her driving with less eye movements than the eye movements when viewing a display inside the vehicle.

For the same reason, the driver's eye movement will be less when the virtual image is farther away. Accordingly, it is preferable that a virtual image displayed by the head-up display device preferably be formed farther with respect to the vehicle (see, Patent Document 1). Patent Document 1 discloses a lens optical system of a head-up display device that displays a display image farther away despite the fact that the head-up display device has been downsized.

### CITATION LIST

### Patent Literature

[PTL 1] Japanese Unexamined Patent Application Publication No. 2013-047698

### SUMMARY OF INVENTION

### Technical Problem

However, when a virtual image is projected at a distance, the driver may feel incongruity when viewing the virtual image from the driver's position. Such a case may be described in the following example. When the vehicle travels straight ahead, a traveling direction of the vehicle matches a direction of the vehicle body. As a result, the virtual image displayed by the head-up display device fixed to the vehicle body is also displayed in the same direction as the traveling direction. By contrast, when the vehicle is traveling on a turning course, the driver turns his or her line of sight farther inside a turning direction relative to the direction of the vehicle body (in the case of traveling turning towards the left, the leftward direction relative to the direction of the vehicle body). However, since the head-up display device is fixed to the vehicle body, the direction in which the virtual image is displayed is a front direction determined by the orientation of the vehicle body, which generates a deviation between the direction of the driver's line of sight and the display direction of the virtual image displayed by the head-up display device. When the virtual image is displayed far from the vehicle, this deviation increases, thereby giving the driver an incongruent sense.

Such an appearance of the virtual image may occur not only during traveling on a turning course when the yaw angle of the vehicle changes, but may similarly occur in changing other orientations of the vehicle, such as when the roll angle and the pitch angle of the vehicle change.

In view of the above-described problems, one aspect of the present invention is directed to providing a display device for displaying an image that gives less sense of incongruity to an occupant.

### Solution to Problem

According to one embodiment of the present invention, a display device for displaying a virtual image so as to be visually perceived by an occupant of a moving body through a transparent member is provided. The display device includes

an image generator configured to generate an image to be displayed as a virtual image;

an orientation information acquisition unit configured to acquire information on an orientation of the moving body; and

a display change processor configured to change the display of the virtual image in accordance with the information on the orientation acquired by the orientation information acquisition unit.

### Advantageous Effects of Invention

According to an aspect of the embodiments, it is possible to provide a display device for displaying an image to an occupant so as to reduce a sense of incongruity caused by the display of the image.

### BRIEF DESCRIPTION OF DRAWINGS

FIG. 1 is a diagram illustrating an example of floating feeling due to a virtual image;

FIG. 2A is a diagram schematically illustrating an example of operations of the HUD device;

FIG. 2B is a diagram schematically illustrating the example of operations of the HUD device;

FIG. 2C is a diagram schematically illustrating the example of operations of the HUD device;

FIG. 3A is a diagram schematically illustrating an example of an in-vehicle HUD device;

FIG. 3B is a diagram schematically illustrating an example of an in-vehicle HUD device;

FIG. 4 is a diagram illustrating a configuration of an optical unit of the HUD device;

FIG. 5 is a configuration diagram of a display system of a vehicle in which a HUD device is installed;

FIG. 6 is a diagram illustrating a hardware configuration of a controller;

FIG. 7 is a functional block diagram illustrating examples of functions of the HUD device;

FIG. 8 is a diagram schematically illustrating an example of a vehicle turning left at an intersection;

FIG. 9 includes diagrams schematically illustrating examples of an image generated by an image generator and a virtual image to be projected;

FIG. 10A is a diagram illustrating an example of an image in a case where information is formed in an entire image memory;

FIG. 10B is a diagram illustrating an example of an image in a case where information is formed in the entire image memory;

FIG. 11 is a flowchart illustrating an example of a procedure in which the HUD device displays an image so as to be visually perceived by a driver through a transparent member;

FIG. 12A is a diagram illustrating an example of image processing for reducing floating feeling;

FIG. 12B is a diagram illustrating an example of image processing for reducing floating feeling;

FIG. 12C is a diagram illustrating an example of image processing for reducing floating feeling;

FIG. 12D is a diagram illustrating an example of image processing for reducing floating feeling;

FIG. 12E is a diagram illustrating an example of image processing for reducing floating feeling;

FIG. 13 is a flowchart illustrating an example of a procedure in which the HUD device displays an image so as to be visually perceived by a driver through a transparent member;

FIG. 14 is a functional block diagram illustrating examples of functions of the HUD device;

FIG. 15 is a flowchart illustrating an example of a procedure in which the HUD device displays an image so as to be visually perceived by a driver through a transparent member (second embodiment);

FIG. 16 is a diagram illustrating a configuration of an optical unit of the HUD device (third embodiment);

FIG. 17 is a diagram illustrating a driving direction of a concave minor;

FIG. 18 is a functional block diagram illustrating examples of functions of the HUD device (third embodiment);

FIG. 19 is a flowchart illustrating an example of a procedure in which the HUD device displays an image so as to be visually perceived by a driver through a transparent member (third embodiment);

FIG. 20 includes diagrams each illustrating a deviation between an orientation (rotation) or direction of an image determined by a roll or pitch of a vehicle and a direction of the driver's line of sight;

FIG. 21 is a functional block diagram illustrating examples of functions of a HUD device (fourth embodiment);

FIG. 22 is a flowchart illustrating an example of a procedure in which the HUD device displays an image so as to be visually perceived by a driver through a transparent member (fourth embodiment);

FIG. 23A is a diagram schematically illustrating an example of an image generated by an image generator and a virtual image to be projected;

FIG. 23B is a diagram schematically illustrating an example of an image generated by the image generator and a virtual image to be projected;

FIG. 23C is a diagram schematically illustrating an example of an image generated by the image generator and a virtual image to be projected;

FIG. 23D is a diagram schematically illustrating an example of an image generated by the image generator and a virtual image to be projected;

FIG. 24A is a diagram schematically illustrating an example of an image generated by the image generator and a virtual image to be projected;

FIG. 24B is a diagram schematically illustrating an example of an image generated by the image generator and a virtual image to be projected;

FIG. 24C is a diagram schematically illustrating an example of an image generated by the image generator and a virtual image to be projected;

FIG. 24D is a diagram schematically illustrating an example of an image generated by the image generator and a virtual image to be projected;

FIG. 25A is a diagram illustrating a configuration example of a system having a HUD device and a server configured to generate an image for reducing floating feeling; and

FIG. 25B is a diagram illustrating a configuration example of a system having a HUD device and a server configured to generate an image for reducing floating feeling.

### DESCRIPTION OF EMBODIMENTS

The following illustrates a head-up display device and an image processing method performed by the head-up display device with reference to the accompanying drawings as embodiments of a mode for carrying out the present invention.

### First Embodiment

Floating Feeling Due to Virtual Image

The following description is given using the term a “driver” who is seated in a driver's seat, as an example of an occupant. Note that the effect of the following embodiments will be obtained irrespective of the presence or absence of driving insofar as a driver is seated in a predetermined seat. A head-up display device (hereinafter referred to as a “HUD device”) according to an embodiment is configured to reduce an incongruent sense, which is felt by a driver when the direction of the vehicle body deviates from the direction of the driver's line of sight. As an example of such an incongruent sense in a case where the direction of the vehicle body deviates from the direction of the driver's line of sight, an illustration is given of a floating feeling of a virtual image felt by a driver in a case of the distance from the vehicle to the virtual image being long. A floating feeling is a sense of incongruity felt by a driver due to a deviation between the real world and the virtual image; however, the way of expressing the sense of incongruity may vary between people; examples of such expression includes an unsteady feeling, a swaying sensation, virtual sickness, or difficulty in viewing.

Further, in defining a distance from the vehicle to the virtual image being long, a constant threshold distance beyond which all drivers start to experience a floating feeling is not necessarily indicated; the distance at which a driver starts to experience a floating feeling may vary between individuals. Therefore, a distance from the vehicle to the virtual image being long may indicate a distance at which a floating feeling is felt by a consistent proportion of multiple drivers or more who are taken as subjects for measuring a floating feeling. In the present embodiment, a distance from the vehicle to the virtual image being long may be expressed as a distance from the vehicle to the virtual image being not less than a threshold, for convenience of illustration.

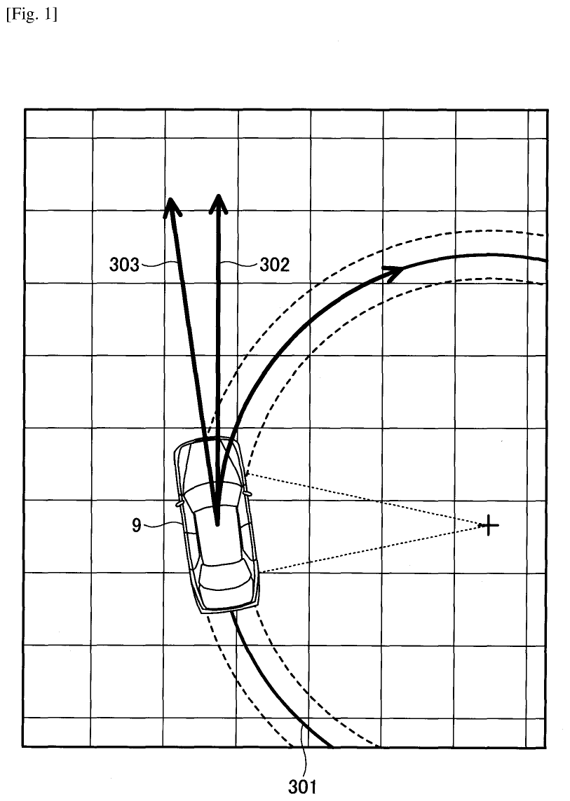

FIG. 1 is a diagram illustrating an example of a floating feeling due to a virtual image. A vehicle 9 in FIG. 1 is provided with a HUD device and on a right-turning course. Since a steering angle is steered rightward relative to the center state, the vehicle 9 moves along a circumferential direction of a circle 301, and an instantaneous traveling direction is a tangential direction 302 of the circle 301. Meanwhile, a direction 303 of the vehicle body faces the outside of the tangential direction 302 due to the inner-side wheel difference. The driver identifies the tangential direction 302, which is a vehicle traveling direction, as a psychological traveling direction of the vehicle. However, the tangential direction 302 differs from a vehicle body direction 303, which is a virtual image display direction in which a virtual image is actually displayed. Such a difference will result in a mental image error for the driver who is viewing the virtual image and the real world simultaneously. This mental image error is felt as the above-described floating feeling.

More specifically, a floating feeling may be expressed as follows:

A. A sense of incongruity of a virtual image appearing fixed to the front of a vehicle being inconsistent with a large movement of the background accompanying the steering.

B. A sense of incongruity of the virtual image appearing fixed to the front of a vehicle being inconsistent with the shape of a lane (curve etc.).

The HUD device of the present embodiment is configured to reduce a sense of incongruity typified by the above-described floating feeling, which is experienced by a driver during traveling on a turning course (i.e., cornering). Specifically, the HUD device of the present embodiment is configured to perform a process of reducing a change in an appearance of a projected virtual image caused by a change in a vehicle's orientation when an orientation of the vehicle is no longer along a straight line.

Outline of Operations of HUD Device According to the Present Embodiment

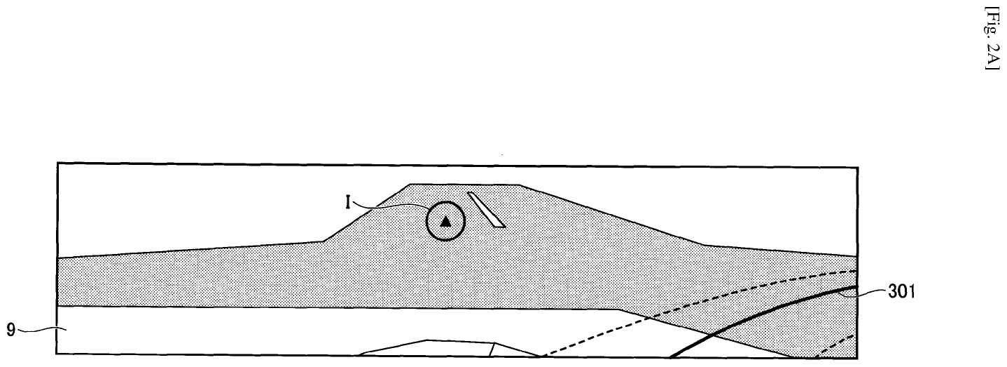

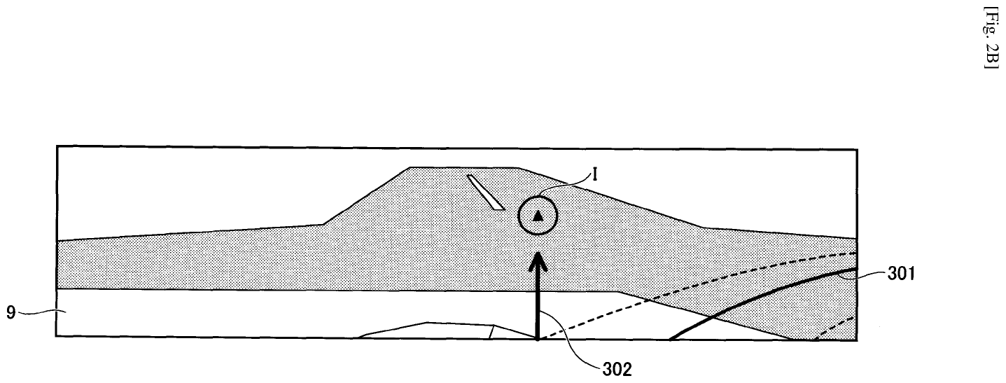

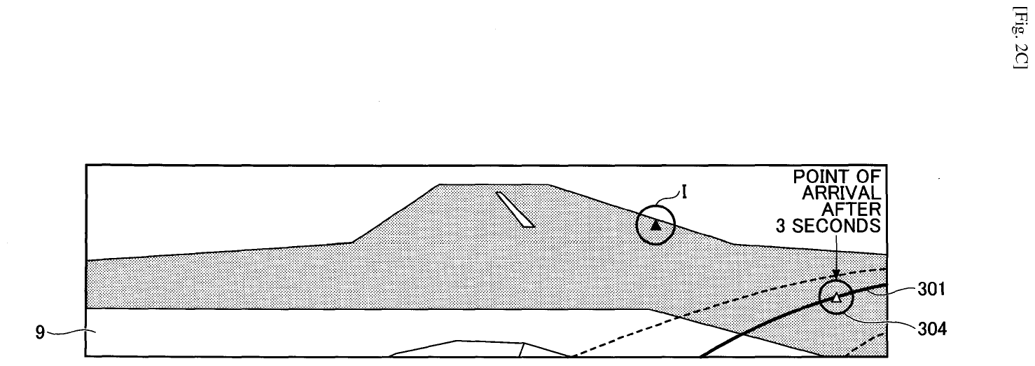

FIGS. 2A, 2B, and 2C are diagrams schematically illustrating an outline of operations of the HUD device according to the present embodiment. First, FIG. 2A is a diagram illustrating a conventional display position of a virtual image I. In FIG. 2A, the vehicle 9 right-turn travels along a circumferential direction of a circle 301. However, the conventional HUD device displays a virtual image I at the front of the vehicle determined by the orientation (direction) of the vehicle body.

FIG. 2B is a diagram illustrating a tangential direction 302 of the circle 301, which is a psychological traveling direction of the vehicle 9. The HUD device of the present embodiment displays a virtual image I in the psychological traveling direction (tangential direction 302) of the vehicle 9. As a result, since the driver's psychological traveling direction matches the displaying direction of the virtual image I with respect to the driver, the deviation between the direction of the driver's line of sight and the display direction of the virtual image I is reduced. Thus, the HUD device may be enabled to reduce the above-described floating feeling. That is, even if the orientation of the vehicle 9 changes, the HUD device may be enabled to reduce a change in appearance of the virtual image I, thereby reducing the floating feeling. Note that the traveling direction of the vehicle 9 is detected by a steering angle or the like as described later.

Further, as illustrated in FIG. 2C, the HUD device may display the virtual image I in consideration of an arrival point 304 at which the vehicle 9 will have arrived a few seconds later. FIG. 2C is a diagram illustrating a display position of the virtual image I displayed in consideration of the arrival point 304 at which the vehicle 9 will have arrived a few seconds later. The driver closely views a forward landscape ahead of the vehicle 9 by predicting the position of the vehicle 9 moving along the circle 301, and hence, the driver may be viewing a further inner side relative to the tangential direction 302 of the circle 301 along the turning direction. Accordingly, the HUD device changes the display position of the virtual image I to the inner side along the turning direction in consideration of the arrival point 304 at which the vehicle 9 will have arrived a few seconds later. As a result, the deviation between the direction of the driver's line of sight and the display direction of the virtual image I is further reduced, thereby reducing the above floating feeling. That is, even if the orientation of the vehicle 9 changes, the HUD device may be enabled to reduce a change in appearance of the virtual image I, thereby reducing the floating feeling. Note that the arrival point at which the vehicle 9 will have arrived several seconds later is detected by the steering angle, the vehicle speed, and the like.

### Definitions of Terms

A moving body is an object that moves by power or human power. The moving body corresponds to, for example, an automobile, a light vehicle, a powered motorcycle (referred to as a motorcycle), and the like. In the present embodiment, the moving body is described with a vehicle traveling on four wheels as an example. Note that the moving body may include pedestrians as per legislation such as electric wheelchairs. The moving body may also include an airplane, a ship, and a robot.

The information on the orientation of the moving body indicates information, from which one or more of the yaw angle, the roll angle, or the pitch angle of the moving body, or a change thereof may be detectable. In the present embodiment, the information on the yaw angle of the orientation is referred to as shift amount relation information, the information on the roll angle is referred to as rotation angle relation information, and the information on the pitch angle is referred to as vertical shift amount relation information.

A process of changing an appearance of a virtual image includes not only a process performed on an image before being projected so as not to impair the visibility but also includes a process performed at the time of projecting an image.

Maintaining the visibility constant indicates not to impair the visibility, that is, to reduce the driver's sense of incongruity with the virtual image. This includes making a virtual image undisplayed (or making it extremely difficult for a driver to see the virtual image being displayed by softening the shade of a color or the like of the virtual image).

A change in appearance of the virtual image given by a change in an orientation of the moving body indicates a change in appearance of the virtual image before vs. after the orientation changes in accordance with the psychological traveling direction of the driver, the direction of the driver's line of sight, and the like. In the present embodiment, such a change is described with the term “floating feeling” or “sense of incongruity” used in the broad sense.

A person who views a virtual image is a person who drives or manipulates a moving body, and the name for such a person may be one suitable for the moving body. Examples of such a name include a driver, an occupant, a pilot, an operator, a user, etc. of a vehicle.

The display mode of the virtual image indicates a state in which the virtual image is displayed. Examples of the display mode include a position, an angle, or the like of the virtual image to be displayed.

An image refers to a shape or appearance of an object reflected by refraction or reflection of light. Examples of an image include still images and moving images.

Configuration Example

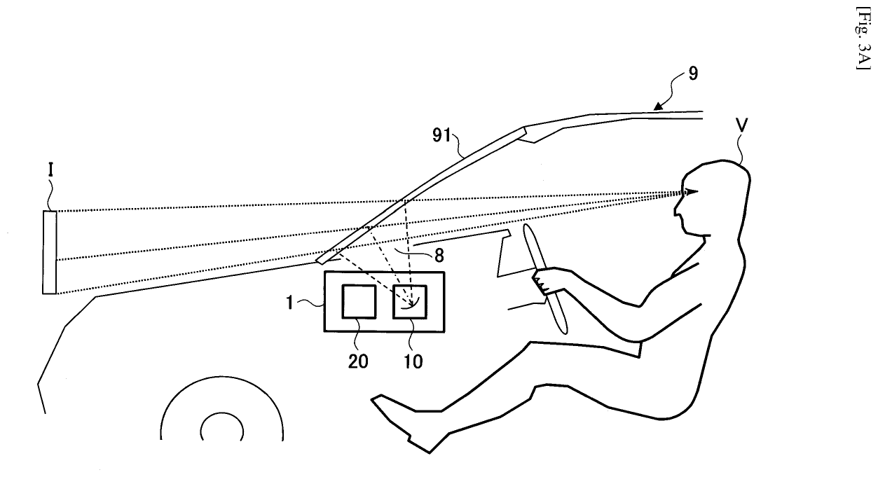

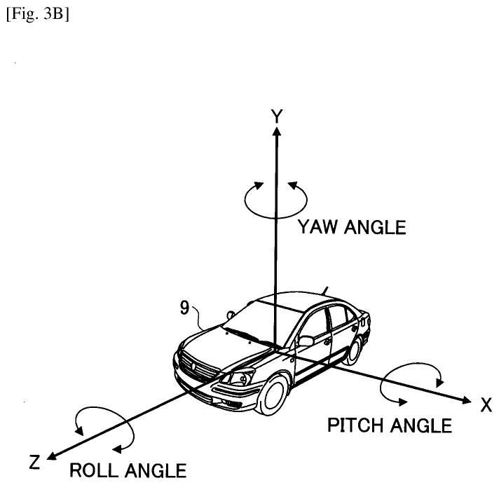

FIGS. 3A and 3B are diagrams each illustrating an example of an outline of an in-vehicle HUD device 1 and an orientation (pitch angle, yaw angle, roll angle) of the vehicle. As illustrated in FIG. 3A, the HUD device 1 is installed on the vehicle 9. The HUD device 1 is embedded in the dashboard, and is configured to project an image from an emission window 8 provided on the upper surface of the HUD device 1 toward the windshield 91. The projected image is displayed as a virtual image I ahead of the windshield 91. Hence, the HUD device 1 is an aspect of a display device. The driver V is enabled to visually observe information that supports his or her driving while keeping his or her line of sight (with a small gaze movement) on a preceding vehicle and on the road surface ahead of the vehicle 9. The information that supports the driver's driving may be any information, an example of which may be the vehicle speed, and examples other than the vehicle speed will be described later. Note that the HUD device 1 may be any type insofar as the HUD device 1 is configured to project an image on or toward the windshield 91, and the HUD device 1 may be installed on a ceiling, a sun visor, etc. in addition to a dashboard.

The HUD device 1 may be a general-purpose information processing terminal or a HUD-dedicated terminal. The HUD dedicated terminal is simply referred to as a head-up display device, and when integrated with the navigation device, the HUD dedicated terminal may be referred to as a navigation device. The HUD dedicated terminal is also called a PND (Portable Navigation Device). Alternatively, the HUD dedicated terminal may be called display audio (or connected audio). Display audio is a device that mainly provides an AV function and communication function without incorporating a navigation function.

Examples of the general-purpose information processing terminal include a smartphone, a tablet terminal, a mobile phone, a PDA (Personal Digital Assistant), a notebook PC, and a wearable PC (e.g., a wristwatch type, a sunglass type). The general-purpose information processing terminal is not limited to these examples, and may only include functions of a general information processing apparatus. A general-purpose information processing terminal is usually used as an information processing apparatus that executes various applications. For example, when executing application software for a HUD device, the general-purpose information processing terminal displays information for supporting a driver's driving, similarly to the HUD-dedicated terminal.

The HUD device 1 according to the present embodiment may be switched between a vehicle mounted state and a portable state in any one of a general purpose information processing terminal and a HUD dedicated terminal.

As illustrated in FIG. 3A, the HUD device 1 includes an optical unit 10 and a controller 20 as main components. As a projection method of the HUD device 1, a panel method and a laser scanning method are known. The panel method includes forming an intermediate image by an imaging device such as a liquid crystal panel, a DMD panel (digital mirror device panel), a fluorescent display tube (VFD) or the like. The laser scanning method includes scanning a laser beam emitted from a laser light source by a two-dimensional scanning device to form an intermediate image.

The laser scanning method is suitable because, unlike a panel method in which an image is formed by partial light shielding of full screen emission, in a laser scanning method, light emission/no light emission is assigned to each pixel so as to form a high-contrast image. In the present embodiment, an example of adopting the laser scanning method as a projection system of the HUD device 1 will be described, but such a projection system of the HUD device 1 is only an example and any projection system capable of performing a process of reducing the floating feeling may be used.

FIG. 3B is a diagram illustrating the pitch angle, the yaw angle, and the roll angle of the vehicle 9. Rolling indicates that an object such as a moving body with predetermined orientations of front and back, left and right, up and down rotate (or tilt) with respect to a depth axis (Z axis in the figure); pitching indicates that such an object rotates (or tilts) with respect to a horizontal axis (X axis in the drawing); and yawing indicates that such an object rotates (or tilts) with respect to a vertical axis (Y axis in the figure). Further, the respective rotation amounts or inclination amounts are referred to as a roll angle, a pitch angle, and a yaw angle.

FIG. 4 is a diagram illustrating a configuration example of an optical unit 10 of the HUD device 1. The optical unit 10 mainly includes a light source unit 101, an optical deflector 102, a minor 103, a screen 104, and a concave minor 105. Note that FIG. 4 merely illustrates main components of the HUD device 1.

The light source unit 101 includes, for example, three laser light sources (hereinafter referred to as laser diodes LDs) corresponding to RGB, a coupling lens, an aperture, a combining element, a lens, and the like. The light source unit 101 is configured to combine laser beams emitted from the three LDs and guide the combined laser beam toward a reflecting surface of the optical deflector 102. The laser beam guided to the reflecting surface of the optical deflector 102 is two-dimensionally deflected by the optical deflector 102.

As the optical deflector 102, for example, one micro-minor oscillating with respect to two orthogonal axes, two micro-mirrors oscillating with respect to or rotating around one axis, and the like may be used. The optical deflector 102 may be, for example, MEMS (Micro Electro Mechanical Systems) manufactured by a semiconductor process or the like. The optical deflector 102 may be driven by, for example, an actuator using the deforming force of a piezoelectric element as a driving force. As the optical deflector 102, a galvanometer minor, a polygon mirror, or the like may be used.

The laser beam two-dimensionally deflected by the optical deflector 102 enters the mirror 103, is returned by the minor 103, and renders a two-dimensional image (intermediate image) on the surface (surface to be scanned) of the screen 104. As the mirror 103, for example, a concave minor may be used; however, alternatively, a convex mirror or a plane mirror may be used. By deflecting the direction of the laser beam by the optical deflector 102 and the minor 103, it is possible to flexibly change the size of the HUD device 1 or the arrangement of the components.

As the screen 104, it is preferable to use a microlens array or micromirror array having a function of diverging the laser beam at a desired divergence angle; however, it may also be preferable to use a diffusing plate for diffusing the laser beam, or a transparent plate or a reflecting plate with a smooth surface or the like may be used.

The laser beam emitted from the screen 104 is reflected by the concave mirror 105 and projected onto the windshield 91. The concave minor 105 has a function similar to a lens and has a function of forming an image at a predetermined focal length. Accordingly, a virtual image I is displayed at a position determined by the distance between the screen 104 corresponding to an object and the concave minor 105, and by the focal length of the concave mirror 105. In FIG. 4, since the laser beam is projected on the windshield 91 by the concave mirror 105, a virtual image I is displayed (formed) at a position at a distance L from the viewpoint E of the driver V.

At least a part of light flux to the windshield 91 is reflected toward the viewpoint E of the driver V. As a result, the driver V is enabled to visually perceive the virtual image I, which is an intermediate image of the screen 104 enlarged through the windshield 91. That is, as viewed from the driver V, the intermediate image is enlarged and displayed as a virtual image I through the windshield 91.

Note that the windshield 91 is usually not flat but slightly curved. Therefore, not only the focal length of the concave mirror 105 but also the curved surface of the windshield 91 determines an image forming position of the virtual image I. The condensing power of the concave mirror 105 is preferably set such that the virtual image I is displayed at a position (depth position) where the distance L from the viewpoint E of the driver V to the image forming position of the virtual image I is 4 m or more and 10 m or less (preferably 6 m or less).

Note that due to the effect of the windshield 91, optical distortion occurs in which the horizontal line of the intermediate image becomes convex upward or downward; hence, at least one of the mirror 103 and the concave mirror 105 is preferably designed and arranged so as to correct distortion. Alternatively, it is preferable that the projected image is corrected in consideration of distortion.

In addition, a combiner may be disposed as a transmitting-reflecting member on the viewing point E side of the windshield 91. When the combiner is irradiated with light from the concave mirror, the virtual image I may be displayed in a manner similar to the case where the windshield 91 is irradiated with light from the concave mirror 105. Note that “displaying a virtual image” means displaying an image visually perceivable by a driver through a transparent member; however, the “displaying a virtual image” is used in the description in some cases for simplifying the explanation.

Further, instead of projecting an image on the windshield 91, the windshield 91 may be configured to emit light to display the image.

Configuration Example of Display System of Vehicle Installed HUD Device

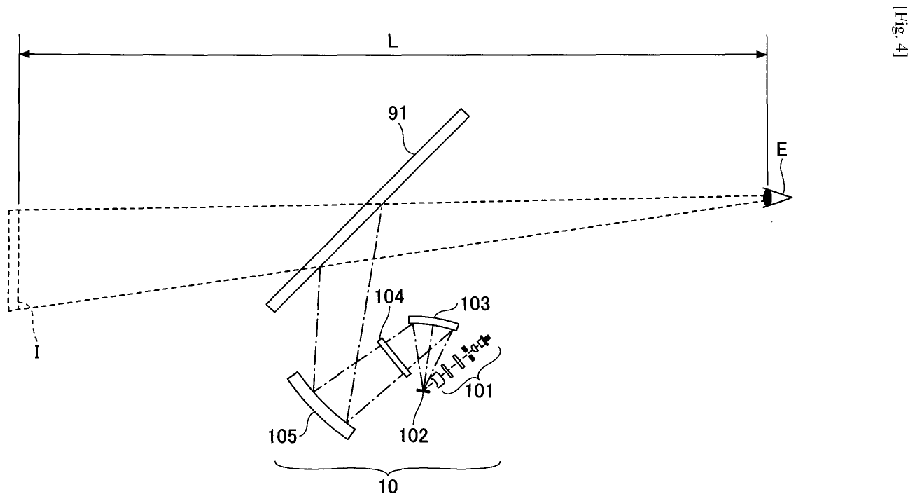

FIG. 5 is a configuration diagram of a display system 150 of a vehicle on which a HUD device is installed. The display system 150 includes a car navigation system 11 that communicates via an in-vehicle network NW such as a CAN (Controller Area Network), a steering angle sensor 12, a HUD device 1, a seating sensor 13, a vehicle height sensor 14, a vehicle speed sensor 15, and a gyro sensor 16.

The car navigation system 11 has a Global Navigation Satellite System (GNSS) typified by GPS, detects the current position of the vehicle, and displays the position of the vehicle on an electronic map. The car navigation system 11 also receives inputs of a departure place and a destination, searches for a route from the departure place to the destination, displays the route on the electronic map, or guides, before the course change, the traveling direction to the driver by voice, character (displayed on the display), animation or the like. The car navigation system 11 may communicate with a server via a mobile phone network or the like. In this case, the server may transmit the electronic map to the vehicle 9 and perform a route search.

The steering angle sensor 12 is a sensor for detecting the steering angle of the steering wheels by the driver. The steering angle sensor 12 mainly detects the steering direction and the steering amount. The steering direction and the steering amount may be detected based on any principle; for example, there is a method of counting ON/OFF of light passing through a slit disk that rotates in conjunction with a steering wheel.

The seating sensor 13 is a sensor for detecting whether an occupant is seated in each seat of the vehicle. The seating sensor 13 may detect the presence or absence of seating, for example, with a pressure detection sensor installed in each seat, an infrared sensor or the like. Alternatively, the seating sensor 13 may detect the presence or absence of seating by a camera that images the interior of a vehicle interior.

The vehicle height sensor 14 is a sensor for detecting the vehicle height. The vehicle height may be detected based on any principle; for example, there is a method of detecting the amount of sag of suspension with respect to the vehicle body, as an optical change, as a change in electrical resistance or as a change in magnetoresistance; or there is a method of detecting a distance from the vehicle body to the road surface with a laser or the like.

The vehicle speed sensor 15 detects, for example, the rotations of the wheels with a Hall element or the like, and outputs a pulse wave corresponding to the rotation speed. The vehicle speed sensor 15 detects the vehicle speed from the rotation amount (pulse number) per unit time and the outer diameter of the tire.

The gyro sensor 16 detects an angular velocity indicating a rotation amount per unit time with respect to one or more axes of the XYZ axes illustrated in FIG. 3B. The orientation (yaw angle, pitch angle, and roll angle) may be detected by integrating angular velocity in time. In the present embodiment, it is preferable to detect at least the yaw angle.

The HUD device 1 may acquire information from each sensor installed on the vehicle. Further, the HUD device 1 may acquire information from an external network, not from the in-vehicle network. For example, the HUD device 1 may acquire car navigation information, a steering angle, a vehicle speed, or the like. With regard to the steering angle and the vehicle speed, when automatic driving is put into practical use in the future, it may be possible to control the in-vehicle device by observing the positional orientation and the vehicle speed of the traveling vehicle by ITS (Intelligent Transport Systems).

Configuration Example of Controller

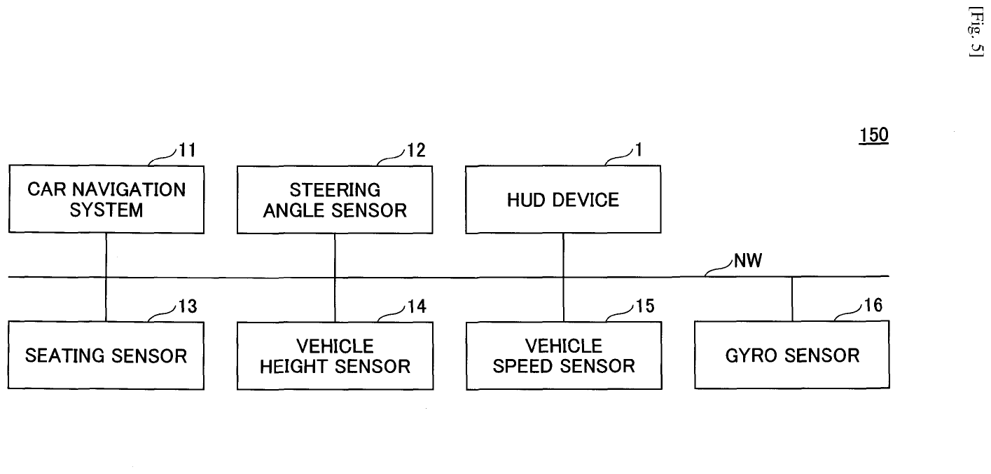

FIG. 6 is a diagram illustrating a hardware configuration of a controller 20. The controller 20 has an FPGA 201, a CPU 202, a ROM 203, a RAM 204, an I/F 205, a bus line 206, an LD driver 207, and a MEMS controller 208. The FPGA 201, the CPU 202, the ROM 203, the RAM 204, and the I/F 205 are mutually connected via the bus line 206.

The CPU 202 controls each function of the HUD device 1. The ROM 203 stores a program 203p, which is executed by the CPU 202 for controlling each function of the HUD device 1. The program 203p is loaded in the RAM 204, which is used as a work area for the CPU 202 to execute the program 203p. The RAM 204 has an image memory 209. The image memory 209 is used for generating an image to be displayed as a virtual image I. The I/F 205 is an interface for communicating with other in-vehicle devices and is connected to, for example, a CAN bus of the vehicle 9 or to the Ethernet (registered trademark).

The FPGA 201 controls the LD driver 207 based on an image created by the CPU 202. The LD driver 207 drives the LD of the light source unit 101 of the optical unit 10 to control light emission of the LD in accordance with an image. The FPGA 201 operates the optical deflector 102 of the optical unit 10 via the MEMS controller 208 such that the laser beam is deflected in a direction corresponding to a pixel position of the image.

Functions of HUD Device

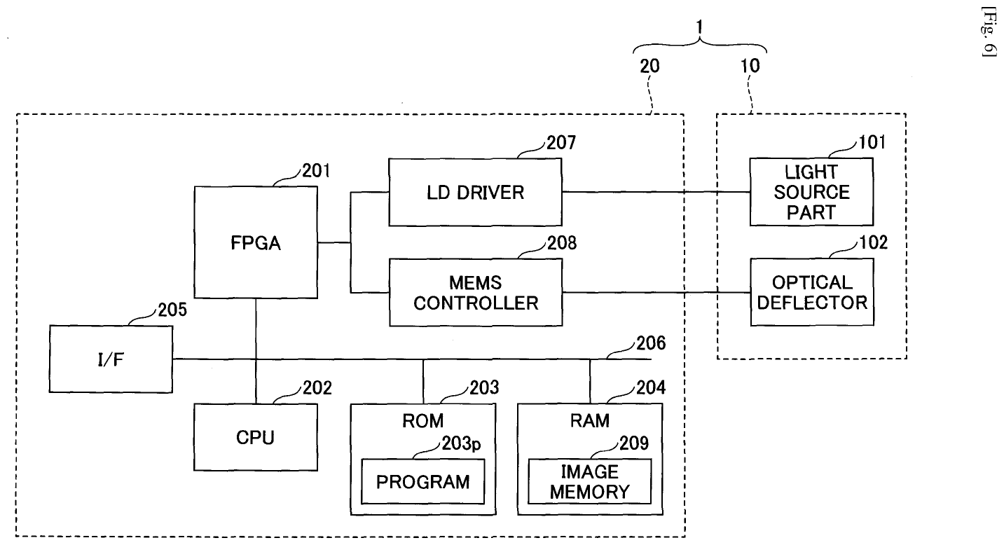

FIG. 7 is a functional block diagram illustrating examples of functions of the HUD device 1. The controller 20 of the HUD device 1 mainly includes an information acquisition unit 21 and an image processor 22. These functions or units of the HUD device 1 are implemented by causing the CPU 202 to execute the program loaded in the RAM 204 from the ROM 203 of the controller 20.

Further, the HUD device 1 has a shift amount table DB 29. The shift amount table DB 29 is storage unit formed in the ROM 203 or the RAM 204. In the shift amount table DB 29, a shift amount table is stored in advance.

The information acquiring unit 21 acquires information (information such as a speed, a steering angle, a traveling distance, and the like) of the vehicle 9 from CAN or the like, and information acquired from the outside by the vehicle 9 such as the Internet or the vehicle information and communication system (VICS) (registered trademark). Information that the information acquisition unit 21 is enabled to acquire may be information flowing through an in-vehicle network such as a CAN, and is not limited to speed, steering angle, traveling distance, and the like. Further, the information acquisition unit 21 may acquire a road map or information for rendering the road map from the vehicle 9. Among the information pieces acquired by the information acquisition unit 21, information for determining the shift amount of an image to reduce the floating feeling is referred to as “shift amount relation information”. In addition, the information acquired by the information acquisition unit 21 will be used as information for supporting a driver, which may be displayed as a virtual image I.

Examples of information for supporting a driver's driving includes a vehicle speed, a traveling direction, a distance to a destination, information on a current position, a state of a traffic light ahead of the vehicle 9, an operation state of an in-vehicle device, signs such as a speed limit, etc., traffic jam information, and the like. Further, the information for supporting a driver's driving may include a detection result of an obstacle ahead of the vehicle 9, a warning on an obstacle, information acquired from the Internet, or the like. Besides the above information, entertainment information output from a television receiver or an AV device may also be included in the information for supporting a driver's driving.

Further, the controller 20 may generate the information that the information acquisition unit 21 acquires from the vehicle 9. For example, speed, acceleration, angular velocity, position information, and the like may be generated by various sensors of the controller 20. Further, when the controller 20 has a communication function connected to the network, information on the Internet may be acquired without intervention of the vehicle 9. When the HUD device 1 also serves as a navigation device, the HUD device 1 has a GPS receiver; thus, based on the position information detected by the GPS receiver, the HUD device 1 is enabled to generate a road map illustrating the position of the vehicle 9 itself or a route to a destination.

The image processor 22 performs processing related to an image to be displayed based on information acquired by the information acquisition unit 21. The image processor 22 further includes an image generator 23, a shift amount determination unit 24, an image shift unit 25, and an image transmitter 26. The image generator 23 generates an image, which is to be output from the optical unit 10 (projecting onto the windshield 91). Since this image contains some types of information, the image generator 23 may also be said to generate information. A simple example of generating information (by the image generator 23) may include a process of converting information acquired by the information acquiring unit 21 into characters or symbols, and displaying the converted characters or symbols. For example, in the case of displaying the vehicle speed, the image generator 23 generates an image “50 km/h” in the image memory 209. The number of pixels and the aspect ratio of the image memory 209 are determined in advance, and coordinate locations of the image memory 209 to which information is generated are determined in advance.

The shift amount determination unit 24 refers to the shift amount table based on the shift amount relation information acquired by the information acquisition unit 21 to determine the shift amount of an image. Some examples of the shift amount tables are illustrated in Table 1.

TABLE 1
(a)

| STEERING ANGLE | SHIFT AMOUNT |
|---|---|
| (DEGREES) | (PIXELS) |
| 1 | N1 |
| 2 | N2 |
| 3 | N3 |
| . . . | . . . |

(b)

| STEERING ANGLE | | SHIFT AMOUNT |
|---|---|---|
| (DEGREES) | VEHICLE SPEED | (PIXELS) |
| 1 | ~10 | Ns1 |
| 2 | ~20 | Ns2 |
| 3 | ~30 | Ns3 |
| . . . | . . . | . . . |

(c)

| YAW RATE | SHIFT AMOUNT |
|---|---|
| (deg/sec) | (PIXELS) |
| ~5 | Ns1 |
| ~10 | Ns2 |
| ~15 | Ns3 |
| . . . | . . . |

(d)

| POSITION INFORMATION | SHIFT AMOUNT |
|---|---|
| (LATITUDE, LONGITUDE) | (PIXELS) |
| LATITUDE 1, LONGITUDE 1 | N1 |
| LATITUDE 2, LONGITUDE 2 | N2 |
| LATITUDE 3, LONGITUDE 3 | N3 |
| . . . | . . . |

The shift amount table (a) in Table 1 indicates a shift amount table when the shift amount relation information is used as a steering angle. In this shift amount table (a), the shift amount is registered in association with the steering angle. For example, when the steering angle is 1 degree, the shift amount is registered so as to shift the image to N1 pixels right (or left). “To shift” an image is to move an image formed in the image memory 209 from its original position or to change the location where the image is formed.

The steering angle is attached with the sign of the steering in the right direction being plus (or minus) and with the sign of the steering in the left direction being minus (or plus), on the basis of the center state of the steering. Accordingly, the shift amount of the shift amount table also has a plus or minus sign according to steering direction. Further, the shift amount may be specified by the number of pixels, the length, or the like.

The amount of a deviation between the display direction of the virtual image I determined by the orientation of the vehicle body and the psychological traveling direction of the vehicle 9 increases as the distance L at which the virtual image I is formed increases. Thus, the shift amount of the shift amount table may be calculated by the developer of the HUD device or the like based on a steering angle and a distance L. Further, in addition to calculation, a shift amount by which the driver V less experiences a floating feeling may be experimentally determined.

The shift amount table (b) in Table 1 indicates a shift amount table when the shift amount relation information is the steering angle and the vehicle speed. In this shift amount table (b), the shift amount is registered in association with the steering angle and the vehicle speed. For example, when the steering angle is 1 degree and the vehicle speed is less than 10 [km/h], the shift amount is registered so as to shift the image to Ns1 pixels right (or left). The relationship between the positive or negative of the steering angle and the direction of the shift amount (right and left) is the same as in the shift amount table (a) in Table 1. As the vehicle speed increases, the arrival point at which the vehicle 9 will have arrived a few seconds later moves in the traveling direction. According to the shift amount table (b) in Table 1, the shift amount determination unit 24 may determine the shift amount in consideration of the arrival point 304 at which the vehicle 9 will have arrived a few seconds later. Note that it may also be possible to determine the shift amount in consideration of the arrival point 304 at which the vehicle 9 will have arrived a few seconds later in the shift amount table (a) in Table 1.

The arrival point 304, at which the vehicle 9 will have arrived a few seconds later, may be calculated by the steering angle and the vehicle speed; however, the driver V may sometimes closely view a view point closer from the driver V than from the arrival point 304. Accordingly, it is not always necessary to calculate the shift amount to reach the arrival point 304; the shift amount may be calculated to reach a point 50% to 90% before the arrival point 304. In addition, there are individual differences in determining the arrival point to be closely viewed by a driver a few seconds later; thus, it is preferable that the developer of the HUD device 1 experimentally determine a shift amount with which the driver V will less experience a floating feeling.

The shift amount table (c) in Table 1 indicates a shift amount table when the shift amount relation information is the yaw rate. In this shift amount table (c), the shift amount is registered in association with the yaw rate. For example, when the yaw rate is less than 5 [degree/sec], the shift amount is registered so as to shift the image to Ns1 pixels right (or left). The yaw rate occurs when the vehicle 9 changes the traveling direction (when the yaw angle is changed). The yaw rate is known to correlate with the steering angle and the vehicle speed, and the shift amount may thus be similarly determined by using the yaw rate as the shift amount relation information. The shift amount table (c) in Table 1 may be calculated from, for example, the yaw rate or may be determined experimentally in advance.

The shift amount table (d) in Table 1 indicates a shift amount table when the shift amount relation information is the position information. In this shift amount table (d), the shift amount is registered in association with the position information. For example, when the position information is latitude 1 and longitude 1, the shift amount is registered so as to shift the image to N1 pixels right (or left).

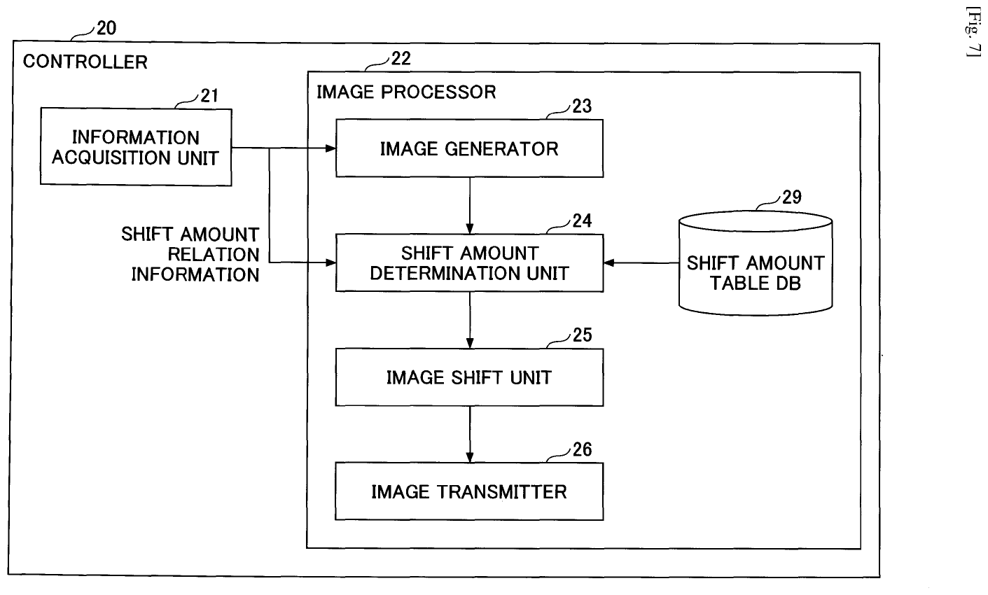

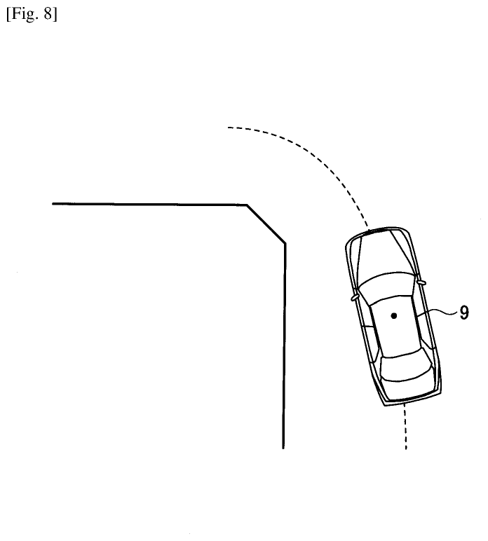

In considering an intersection being defined as a node and a road being defined as a link between the nodes, what route the vehicle passes is clarified in advance by the car navigation system 11; thus, the HUD device 1 may have information as to from which link the vehicle enters each node and from which link the vehicle leaves from the corresponding node. Thus, it is possible to determine the shift amount based on the route information and the position information of the vehicle. Supplemental information to the shift amount table (d) in Table 1 is given with reference to FIG. 8.

FIG. 8 is a diagram schematically illustrating a vehicle 9 turning left at an intersection. The position information of the intersection is registered in road map information as so-called “node position information”. When an angle formed by a link entering a node and a link coming out from the node is equal to or larger than a threshold, the vehicle 9 is steered at this node (the traveling direction is changed). The appropriate degrees of steering may also be determined by the angle formed by the links for each intersection; hence, the shift amount may be calculated in accordance with the angle formed. Alternatively, the developer or the like may experimentally determine the shift amount for each of several positions before vs. after an intersection including the intersection. Alternatively, since the HUD device 1 is enabled to obtain, from the vehicle 9, the steering angle at which the vehicle 9 actually travels on the node, the HUD device 1 uses a shift amount table (a) in Table 1 to be associated with the position information, based on the steering angle to create a shift amount table (d) in in Table 1.

Note that the shift amount may be calculated by a function using the shift amount relation information as a parameter, and the method of determining the shift amount illustrated in any of the shift amount tables (a) to (d) in Table 1 may be only an example.

The following describes by referring back to FIG. 7. The image shift unit 25 shifts an image horizontally (leftward or rightward) by the shift amount determined by the shift amount determination unit 24. That is, the image formed in the image memory 209 is shifted to the right or the left.

The image transmitter 26 transmits (outputs) the image toward the optical unit 10. Specifically, the LD driver 207 converts the image into a control signal of the light source unit 101 to transmit the converted control signal to the light source unit 101; and the MEMS controller 208 converts the image into a control signal of the optical deflector 102 to transmit the converted control signal to the optical deflector 102.

The image projected on the windshield 91 is distorted by the shape of the windshield 91; hence, it is preferable that the image transmitter 26 generates an image corrected in a direction opposite to the direction in which the image is distorted so as not to form such distortion. Further, the image generator 23 may perform the image correction.

Further, the description of the functional block diagram in FIG. 7 merely demonstrates an example of the method of determining the shift amount, and the specific method thereof is not limited to the method illustrated in FIG. 7.

Examples of Images to be Created and Virtual Images

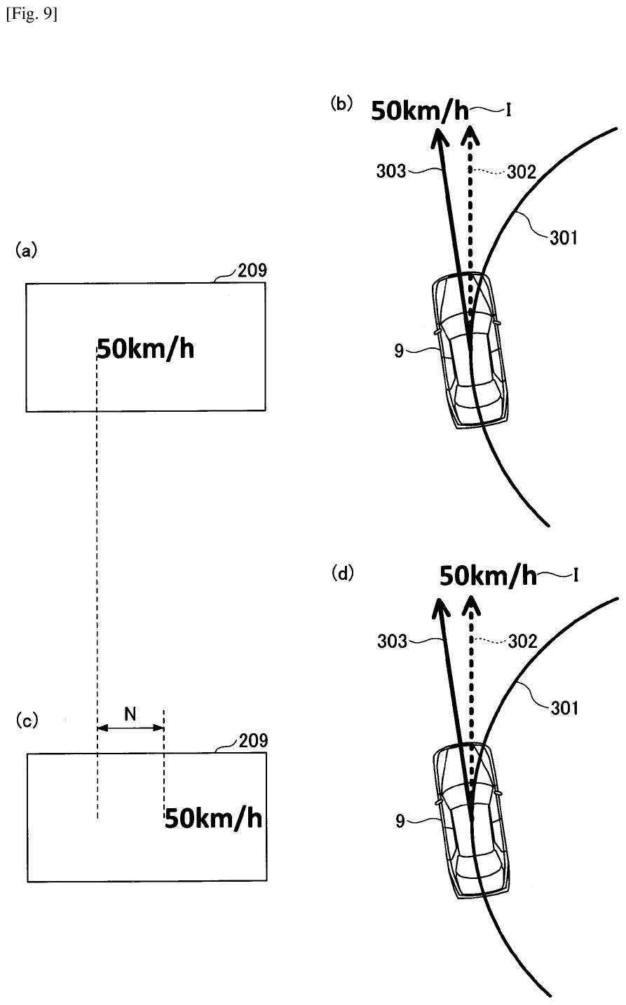

FIG. 9 includes diagrams schematically illustrating an example of an image generated by an image generator 23 and a virtual image I to be displayed. As illustrated in the diagrams in FIG. 9, the vehicle 9 is right turning (traveling while turning right). (a) of FIG. 9 is a virtual image I before an image formed in the image memory 209 is shifted, which is illustrated for comparison. In (a) of FIG. 9, “50 km/h” is formed at the center of the image memory 209. As a result, as illustrated in (b) in FIG. 9, the virtual image I of “50 km/h” is displayed at the front of the vehicle 9 determined by a direction of the vehicle body.

(c) of FIG. 9 is an image formed in the image memory 209 where information is shifted in a turning direction (right direction) by a shift amount N determined by the shift amount relation information and the shift amount table. The shift amount determination unit 24 shifts the virtual image I of “50 km/h” to the right side of the image memory 209 by the shift amount N. Accordingly, as illustrated in (d) of FIG. 9, the virtual image I of “50 km/h” is displayed in a psychological traveling direction of the vehicle 9 (the tangential direction 302 of the circle 301). Thus, it is possible to reduce the difference between a display mode (display position) of the virtual image I determined by an orientation of the vehicle 9 and a display mode (display position) of the virtual image I viewed from a driver V, thereby reducing floating feeling.

Note that the method of shifting an image in the image memory 209 includes a method of shifting an image forming position in the image memory 209 and a method of shifting the entire image memory 209. In this embodiment, an image may be shifted by either method.

Process when Image in Image Memory is Large

In a case where an image formed in the image memory 209 is large, the image may run off depending on the shift amount. Hence, it may be considered to perform processes as follows to manage such runoff.

FIGS. 10A to 10D are diagrams each illustrating an example of an image in a case where information is formed in the entire image memory 209. In FIG. 10A, a road map is formed approximately over the entire image memory 209. When the road map is shifted to the right as a whole in the image memory 209, no road map is formed at the left end of the image memory 209. When shifting the entire image memory 209, predetermined pixel values such as black pixels are set in a portion of the image memory 209 where there are no images. Even in a case where the image is shifted as illustrated in FIG. 10A, a laser beam is not emitted to the black pixels; thus, the left end of the road map is not displayed in front of the vehicle 9. Since a driver V would only feel that the road map became narrower, there will be no serious inconvenience for the driver V.

However, it is also possible to display the entire image formed in the image memory 209 after being shifted. As illustrated in FIG. 10B, the image generator 23 creates a road map, which is not displayed until being shifted, in an additional memory 311 in advance. When the shift amount is determined, the image shift unit 25 slides the image formed in the additional memory 311 to the image memory 209 in accordance with the determined shift amount. As a result, even when the image is shifted, the driver V is still able to see the virtual image I corresponding to the size of the image memory 209.

In FIG. 10B, there is an additional memory 311 only on the left side of the image memory 209; however, an additional memory 311 is also prepared for the right side of the image memory 209.

Operation Procedure

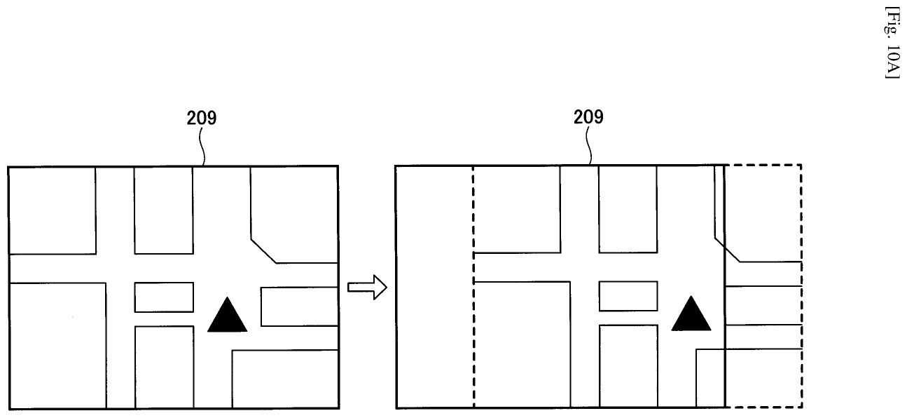

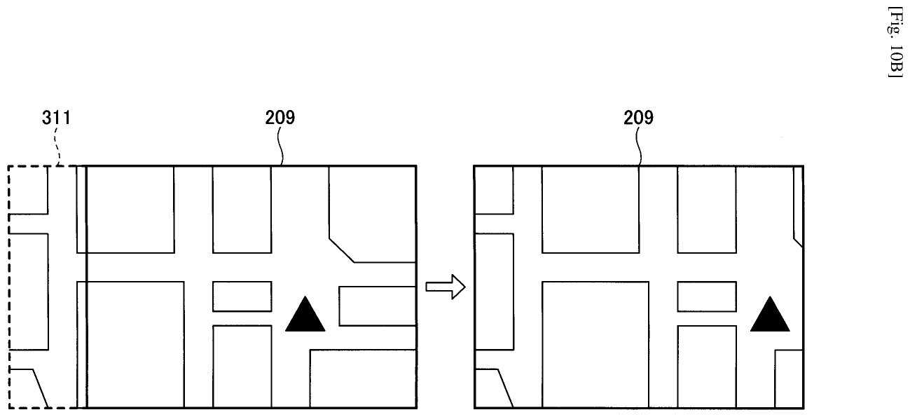

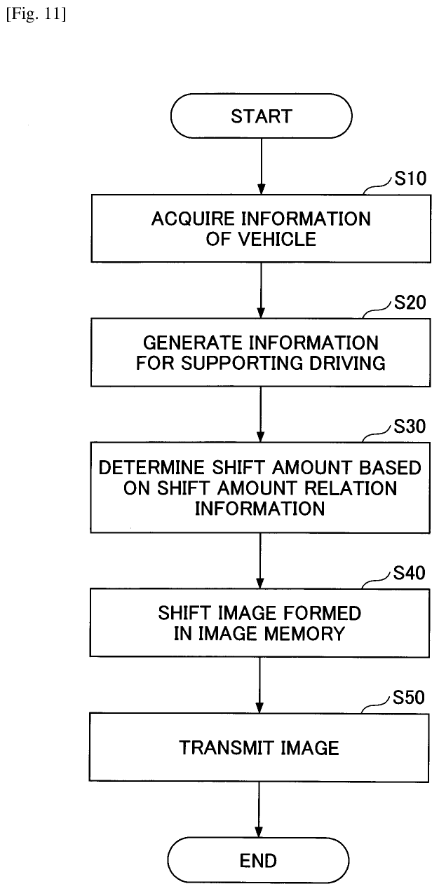

FIG. 11 is a flowchart illustrating an example of a procedure in which the HUD device 1 displays an image so as to be visually perceived by a driver through a transparent member. The process of FIG. 11 is periodically repeated while the HUD device 1 is activated. Note that the process may be executed in a case where the driver V turns on the function of reducing floating feeling.

The information acquisition unit 21 acquires information generated by the vehicle 9 or the HUD device 1 (S10). For example, the information acquisition unit 21 periodically reads information passing through an in-vehicle network such as a CAN. Alternatively, the information acquisition unit 21 may request an electronic control unit (microcomputer) of the in-vehicle network to provide predetermined information. Alternatively, the information acquisition unit 21 may acquire various types of information generated by the HUD device 1.

Next, the image generator 23 generates information for supporting a driver's driving from the information acquired by the information acquisition unit 21 (S20). Note that what type of image will be formed in the image memory 209 is predetermined in advance, in accordance with the information acquired by the information acquisition unit 21.

Next, the shift amount determination unit 24 determines a shift amount using the shift amount relation information included in the information acquired by the information acquisition unit 21 (S30). As described above, the shift amount relation information is the steering angle, the steering angle and the vehicle speed, the yaw rate, the position information, or the like.

Then, the shift amount determination unit 24 refers to a shift amount table to determine a shift direction (right or left) and the shift amount for shifting an image in the image memory 209 (see S30). As a result, by referring to the shift amount table, a direction (shift direction) to shift an image to the right or the left is determined in accordance with the steering angle, and the shift amount is determined in accordance with the steering angle.

The image shift unit 25 shifts the image formed in the image memory 209 by the shift amount in the shift direction determined by the shift amount determination unit 24 (S40). The image transmitter 26 transmits the image toward the optical unit 10 (S50).

Thus, when the orientation of the vehicle 9 changes from straight travel to turning travel, an image in the image memory 209 is shifted based on the orientation of the vehicle 9. As a result, the HUD device 1 is enabled to display the virtual image I with a less apparent floating feeling.

Note that the process depicted in the figure (FIG. 11) is described as being repeated; however, the process may be executed when the vehicle 9 is expected to turn. For example, the process may be executed in the following cases.
A case where the vehicle 9 has reached several meters before the intersection.
A case where a course ahead of the vehicle 9 on the road map forms a curved line with a curvature greater than a threshold.
A case where a route to the destination is set and the vehicle 9 has reached several meters before the intersection at which the vehicle 9 changes a course, or right turns or left turns in this route.

Other Image Processes for Reducing Floating Feeling

In the above description, the floating feeling is reduced by shifting the image in the image memory 209 to the right or left; however, the HUD device 1 is enabled to reduce the floating feeling even in other image processes.

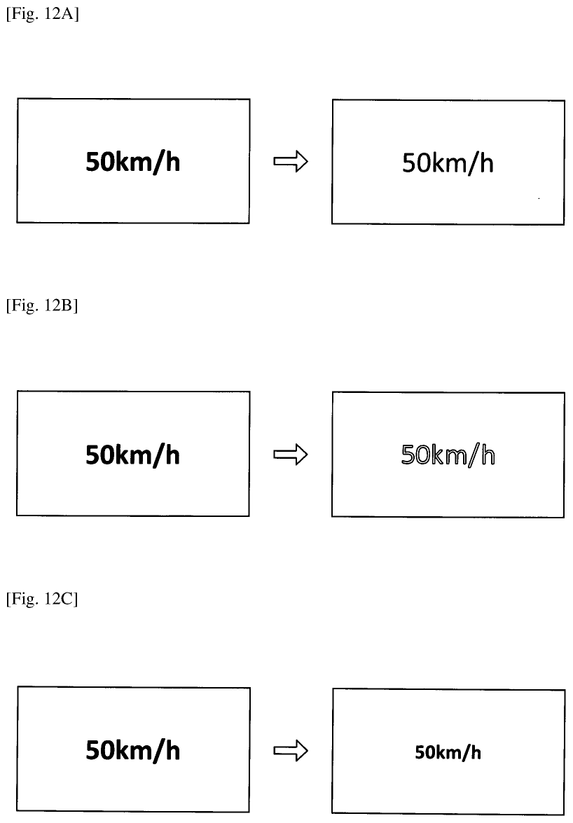

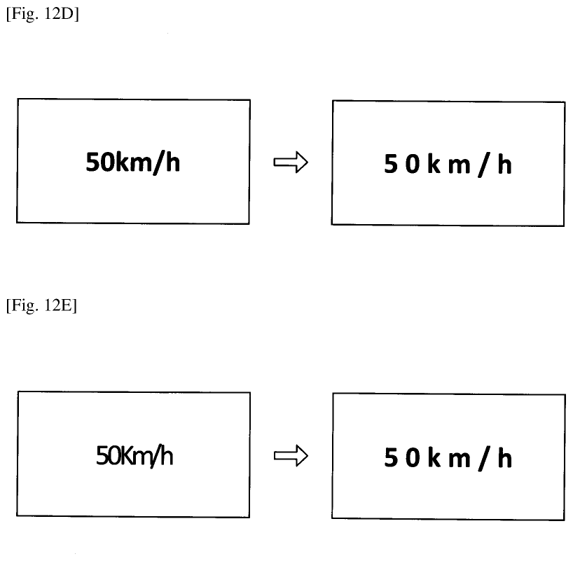

FIGS. 12A to 12E are diagrams illustrating some examples of image processes for reducing floating feeling. In FIG. 12A, an image “50 km/h” is formed in the image memory 209. The image shift unit 25 thins (reduces) information of “50 km/h” based on the shift amount relation information. To thin the information means, for example, changing one or more of hue, lightness, and saturation to change a color of the information to a more inconspicuous (or less conspicuous) color. To thin the information may also mean to change the color shade. For example, to thin the information may mean to change a color to monochrome, or to reduce lightness or saturation. As to the amount to be thinned, the information may be made thinner as the size of the shift amount relation information increases, or may be thinned uniformly when the size of the shift amount relation information is equal to or greater than the threshold. Note that when the shift amount relation information is the position information, the shift amount relation information is the distance from the intersection (the same applies to the description of FIG. 12 noted below). When the image in the image memory 209 becomes thin, the virtual image I displayed in front of the vehicle 9 becomes less conspicuous; as a result, the stimulus to the driver V during turning decreases. Hence, the floating feeling that the driver V feels with the virtual image I during turning may be reduced.

FIG. 12B is a diagram illustrating an image in the image memory 209 with luminance being lowered by the image shift unit 25 based on the shift amount relation information. In a case where an image in the image memory 209 is formed of RGB, the luminance is calculated from RGB. The image shift unit 25 reduces the luminance of the image and then converts the resulting image into RGB. As to the amount of the luminance to be reduced, the luminance may be reduced as the size of the shift amount relation information increases, or the same luminance may be uniformly set when the size of the shift amount relation information is equal to or greater than a threshold. When the luminance of the image in the image memory 209 decreases, the virtual image displayed in front of the vehicle 9 becomes less conspicuous; as a result, the stimulus to a driver V during traveling on a turning course decreases. Accordingly, the floating feeling that the driver V receives from the virtual image I during turning may be reduced. In addition to reducing the luminance, the image “50 km/h” may be made semitransparent.

FIG. 12C is a diagram illustrating an image in the image memory 209 having a size that is reduced by the image shift unit 25 based on the shift amount relation information. The image shift unit 25 reduces the size of the image formed in the image memory 209. As to the size to be reduced, the reduction ratio may be increased as the size of the shift amount relation information increases, or the size of the image may be uniformly reduced at the same reduction ratio when the size of the shift amount relation information is equal to or greater than the threshold. When the size of the image in the image memory 209 decreases, the size of the virtual image displayed in front of the vehicle 9 also decreases; as a result, the stimulus to a driver V during traveling on a turning course decreases. Accordingly, the floating feeling that the driver V receives from the virtual image I during turning may be reduced.

FIGS. 12D and 12E are diagrams each illustrating a case where the width of an image in the image memory 209 is enlarged by the image shift unit 25 based on the shift amount relation information (change in the shape of the image). FIG. 12D indicates an example of an image having a width that is enlarged by providing a gap between characters by the image shift unit 25. FIG. 12E indicates an example in which characters are converted into an image, which is enlarged in the lateral direction. In addition, each character of “50 km/h” may be changed to a wider font.

As to the width to be enlarged, the width may be increased as the size of the shift amount relation information increases, or the width of the image may be uniformly enlarged at the same enlargement ratio when the size of the shift amount relation information is equal to or greater than the threshold. When the width of the image in the image memory 209 becomes wider, the width of the virtual image I displayed in front of the vehicle 9 also becomes wider. Since the deviation between the front direction of the vehicle 9 determined by the direction of the vehicle body and the psychological traveling direction occurs in the horizontal direction, it becomes difficult to see how much the virtual image I has been shifted as the width of the virtual image I becomes wider. Accordingly, the floating feeling that the driver V receives from the virtual image I during turning may be reduced.

The image processes of FIGS. 12A to 12E may be executed in combination with the shifting process of the image in the image memory 209. Further, one or more of the image processes of FIGS. 12A to 12E may be optionally combined.

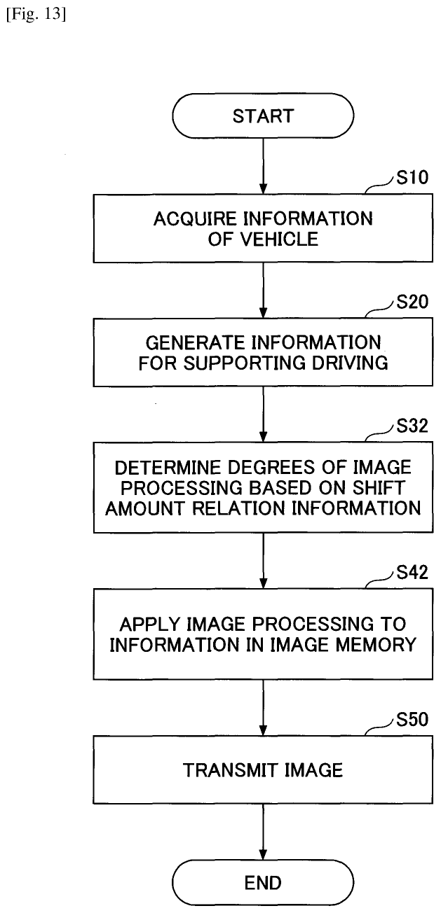

FIG. 13 is a flowchart illustrating an example of a procedure in which the HUD device 1 displays an image so as to be visually perceived by a driver through a transparent member. In the description of FIG. 13, mainly the difference from FIG. 11 will be illustrated. First, the processes in steps S10 and S20 are the same as those in steps S10 and S20 in FIG. 11.

In step S32, the shift amount determination unit 24 determines the degree of image process based on the shift amount relation information and the shift amount table (S32). That is, the shift amount determination unit 24 determines the amount to be thinned, the luminance to be lowered, the size to be reduced, or the width to be reduced in step S32.

Next, the image shift unit 25 applies image processing to the image in the image memory 209 (S42). That is, the image shift unit 25 performs one or more of thinning, lowering the luminance, decreasing the size, or widening the width of the image formed in the image memory 209 in step S42. Note that lowering the luminance may be performed by lowering the output of the LD. The subsequent processes will be the same as those in FIG. 11.

Overview

As described above, the HUD device 1 according to the present embodiment shifts an image formed in the image memory 209 in the horizontal direction to reduce a deviation between the display direction of the virtual image I in the front direction determined by the orientation of the vehicle body and the psychological traveling direction of the vehicle 9. As a result, it is possible to reduce floating feeling sensed by the driver. In addition, it is possible to reduce floating feeling by maintaining the visibility constant (making it less likely to be damaged).

Note that, in the first embodiment, traveling on a turning course (or turning) includes not only turning right or left, but to include cornering (traveling around the corner or traveling along a curve); and further includes course changing, lane changing, and the like. Alternatively, traveling on a turning course (or turning) may be called traveling with yaw rate or with steering.

### Second Embodiment

According to a second embodiment, a description will be given of a HUD device 1 that reduces floating feeling by not displaying the virtual image I while the vehicle 9 is traveling on a turning course.

Reduction in Floating Feeling by not Displaying Image Visible to Driver Via Transparent Member In the first embodiment, a method of reducing the floating feeling while displaying the virtual image I even when the vehicle is traveling on a turning course has been described. However, the HUD device 1 may not display the virtual image I while the vehicle 9 is traveling on a turning course. As a result, a sense of incongruity that the virtual image is fixed to the front of the vehicle contradictory to a large movement of the background accompanying the steering, or a sense of incongruity that the virtual image is fixed to the front of the vehicle contradictory to the shape of the lane (curve, etc.) will not occur in the first place. Hence, it is possible to reduce floating feeling sensed by the driver.

Functions of HUD Device 1

In the second embodiment, the configuration diagram of the HUD device 1 of FIG. 4 described in the first embodiment and the hardware configuration diagram of FIG. 6 are commonly used. In addition, because the components denoted by the same reference numerals in the first embodiment perform the same functions, only the main components of the second embodiment will be described.

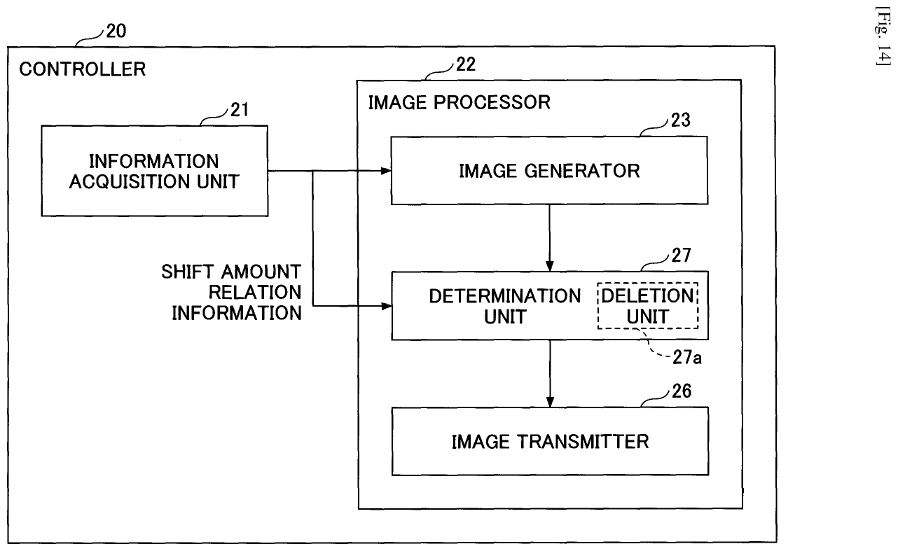

FIG. 14 is a functional block diagram illustrating examples of functions of the HUD device 1 according to the second embodiment. The image processor 22 of the second embodiment includes an image generator 23, a determination unit 27, and an image transmitter 26. The functions of the image generator 23 and the image transmitter 26 may be the same as the functions described in FIG. 7 according to the first embodiment. Further, in the second embodiment, the shift amount table DB 29 is unnecessary.

Based on the shift amount relation information in the first embodiment, the determination unit 27 determines whether to display an image so as to be visually perceived by a driver through the transparent member. According to the second embodiment, the image is not visibly displayed to the driver through the transparent member during traveling on a turning course (cornering). Thus, whether to display an image so as to be visually perceived by a driver through the transparent member may also be referred to as whether the vehicle is traveling on a turning course. Specifically, the HUD device 1 determines whether the steering angle is equal to or greater than a threshold, whether the steering angle and the vehicle speed are equal to or greater than thresholds, respectively, whether the yaw rate is equal to or greater than a threshold, or whether the current position information is included in a place where the vehicle is traveling on a turning course. When these determinations are Yes, the deletion unit 27a of the determination unit 27 eliminates all the images generated by the image generator 23 and outputs the result to the image transmitter 26. Alternatively, the determination unit 27 does not transmit any image to the image transmitter 26 (in this case, the deletion unit 27a becomes unnecessary). With the above methods, the HUD device 1 may make the virtual image I undisplayed.

In the second embodiment, the shift amount relation information should be referred to as non-display determination information or turning determination information; however, since the content of the information is the same, the term “shift amount relation information” will be used as it is in the following description.

Operation Procedure

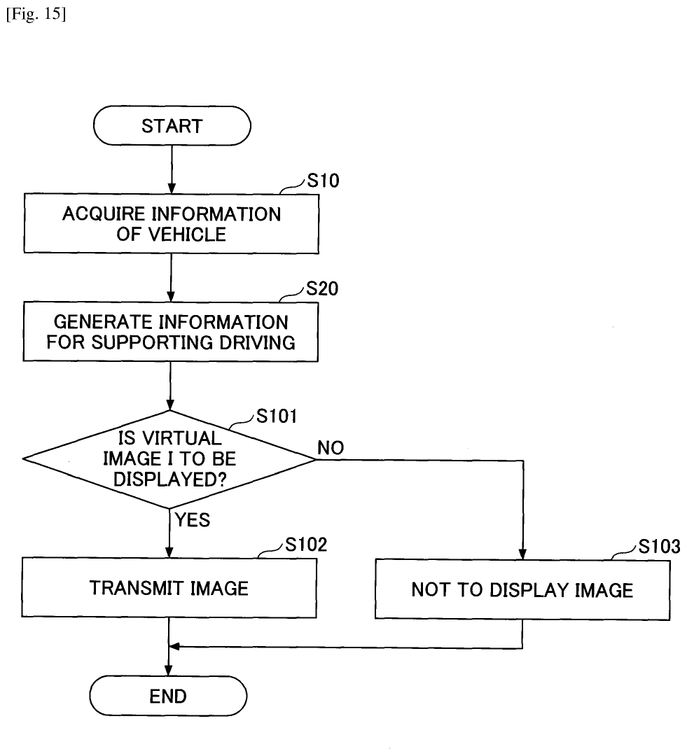

FIG. 15 is a flowchart illustrating an example of a procedure in which the HUD device 1 displays an image so as to be visually perceived by a driver through a transparent member. In the description of FIG. 15, mainly the difference from FIG. 11 will be illustrated. First, the processes in steps S10 and S20 are the same as those in steps S10 and S20 in FIG. 11.

In step S101, the determining unit 27 determines whether to display the virtual image I (whether the vehicle is traveling on a turning course), based on the shift amount relation information (S101). When the vehicle 9 is traveling on a turning course, the determining unit 27 may determine that the image is not displayed to be visually perceived by a driver through the transparent member even at a slow speed; or the determining unit 27 may determine that the image is displayed to be visually perceived by a driver through the transparent member only when the vehicle is traveling on a turning course at a speed higher than a certain speed.

When the determination unit 27 determines to display the virtual image I, the determination unit 27 transmits the image to the image transmitter 26; hence, the image transmitter 26 subsequently transmits the image to the optical unit 10 (S102).

When the determination unit 27 determines not to display the virtual image I, the deletion unit 27a of the determination unit 27 deletes the image in the image memory 209, or the determination unit 27 does not transmit the image to the image transmitter 26; hence, the entire image to be transmitted to the optical unit 10 by the image transmitter 26 will be formed of black pixels. As a result, the HUD device 1 does not display the image as the virtual image I (S103). “Not to display” is equivalent to a process for changing the appearance of the virtual image.

Thus, when the orientation of the vehicle 9 of the vehicle 9 changes from straight travel to turning travel, an image in the image memory 209 is not displayed based on the orientation of the vehicle 9. As a result, the HUD device 1 is enabled to display the virtual image I with a less apparent floating feeling. Further, human visibility may be kept constant in the sense that it will be difficult for a user to feel a sense of incongruity unless the virtual image I is displayed. Note that making it not to display an image includes making it extremely difficult to see an image by thinning the image, lowering the luminance of the image, or lowering the contrast of the image.

Overview

As described above, the HUD device 1 according to the second embodiment does not display the virtual image I while the vehicle 9 is traveling on a turning course; hence, there occurs no deviation between the display direction of the virtual image I in the front direction determined by the direction of the vehicle body and the psychological traveling direction of the vehicle 9, thereby reducing the floating feeling sensed by the driver.

### Third Embodiment

According to a third embodiment, a description will be given of the HUD device 1 that reduces the floating feeling by shifting the entire image under the control of the optical unit 10.

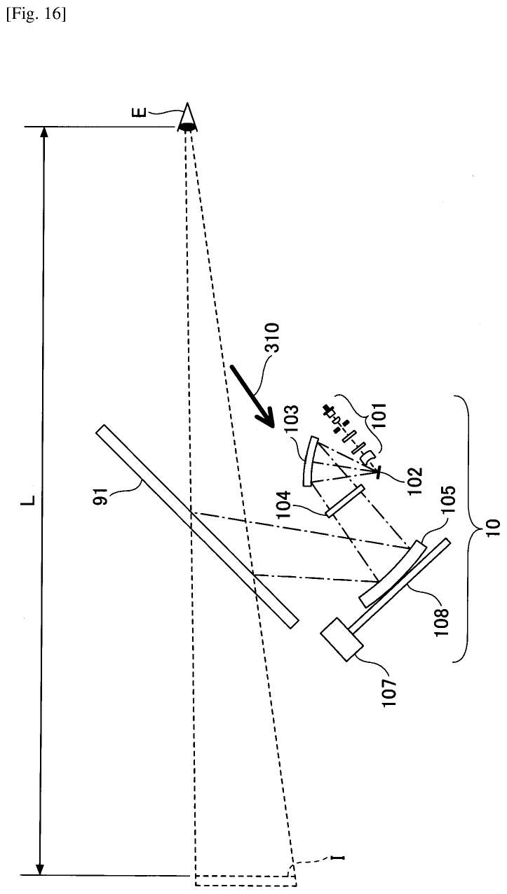

FIG. 16 is a diagram illustrating a configuration example of a HUD device 1 according to a third embodiment. In FIG. 16, since the same components as those in FIG. 4 perform the same functions, only the main components of the third embodiment will be described.

As a method of shifting an image under the control of the optical unit 10, there are a method of controlling a concave mirror 105 and a method of controlling an optical deflector 102. First, a method of controlling the concave minor 105 will be described.

The HUD device 1 according to the third embodiment has an actuator 107. The actuator 107 drives the concave mirror 105 under the control of the controller 20. More specifically, the actuator 107 rotates or oscillates the concave minor 105 such that the laser beam reflected by the concave mirror 105 moves in the horizontal direction of the windshield 91.

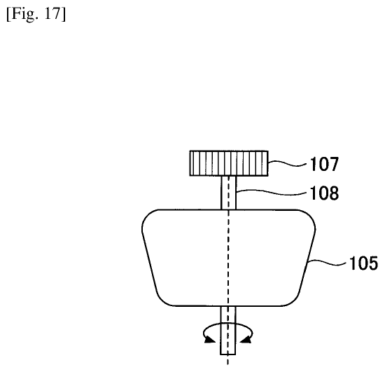

FIG. 17 is a diagram illustrating an example of a driving direction of the concave mirror 105. FIG. 17 is a front diagram of the concave minor 105 viewed from the direction indicated by an arrow 310 (the direction perpendicular to the concave mirror 105) in FIG. 13. As illustrated in FIG. 17, the actuator 107 rotates a rotating member 108 arranged at the center of the concave minor 105. Thereby, the reflection direction of the laser beam may move in the horizontal direction of the windshield 91.

In the example of FIG. 17, the concave minor 105 is rotated; however, the image may similarly be moved in the horizontal direction of the windshield 91 by changing a direction in which the light deflector 102 deflects light. That is, the light deflector 102 increases the deflection angle of the light by the deflection amount toward the back or the front in the depth direction on paper of FIG. 16. As a result, the reflection direction of the laser beam increases in the right direction or the left direction of the windshield 91, and the image moves in the horizontal direction. Since the actuator 107 is unnecessary in changing the deflection direction of light by the optical deflector 102, it is easy to control against the increase in cost. Accordingly, it may be preferable to control the optical deflector 102 rather than to control the concave minor 105.

Further, insofar as the position of the image to be projected on the windshield 91 may be shifted in the horizontal direction, any component of the optical unit 10 may be controlled.

Functions of HUD Device

FIG. 18 is a functional block diagram illustrating examples of functions of the HUD device 1 according to the third embodiment. In the description of FIG. 18, mainly the difference from FIG. 7 will be illustrated. The image processor 22 of the third embodiment includes an image generator 23, an image transmitter 26, a rotation amount determination unit 28, a rotation amount instruction unit 31, and an actuator controller 33. The functions of the image generator 23 and the image transmitter 26 may be the same as those in the first or second embodiment.

The rotation amount determination unit 28 determines a rotation amount of the actuator 107 with reference to a rotation amount table stored in a rotation amount table DB 30. The method of determining the rotation amount may be the same as the method of determining the shift amount in the first embodiment. That is, the amount of rotation is determined based on one or more of the steering angle, the steering angle and the vehicle speed, the yaw rate, and the position information. In the rotation amount table, the rotation amount is set in association with any one of the steering angle, the steering angle and the vehicle speed, the yaw rate, and the position information. In a case where the concave minor 105 is controlled, the amount of rotation is the rotation amount of the actuator 107, and in a case where the optical deflector 102 is controlled, the amount of rotation is the deflection amount of a MEMS mirror. The rotation amount instruction unit 31 indicates, to the actuator controller 33, the rotation amount determined by the rotation amount determination unit 28.

The actuator controller 33 controls the actuator 107 for rotating the concave minor 105 such that the rotation amount of the actuator 107 matches the rotation amount indicated by the rotation amount instruction unit 31. For example, the rotation amount of the actuator 107 that matches the rotation amount indicated by the rotation amount instruction unit 31 may be implemented by a driver circuit for controlling a motor and a PWM circuit.

The steering angle, the steering angle and the vehicle speed, the yaw rate, or the position information in the third embodiment should be referred to as the rotation amount relation information; however, these are referred to as shift amount relation information because the content of each is the same as the shift amount relation information.

When the projection position of the laser beam on the windshield 91 changes, the distance from the concave mirror 105 to the windshield 91 also changes; hence, trapezoidal distortion may occur. Accordingly, it is preferable that the image transmitter 26 or the like corrects trapezoidal distortion in advance.

The optical unit 10 has an image output unit 32 and a projection direction changing unit 38. The image output unit 32 is a function of outputting images and is a function of projecting an image by a light source unit 101, the optical deflector 102, a minor 103, a screen 104, and the concave mirror 105. The projection direction changing unit 38 is implemented by an actuator 107, and changes the direction in which an image is projected based on the direction and the rotation amount in accordance with the control from the actuator controller 33.

Operation Procedure

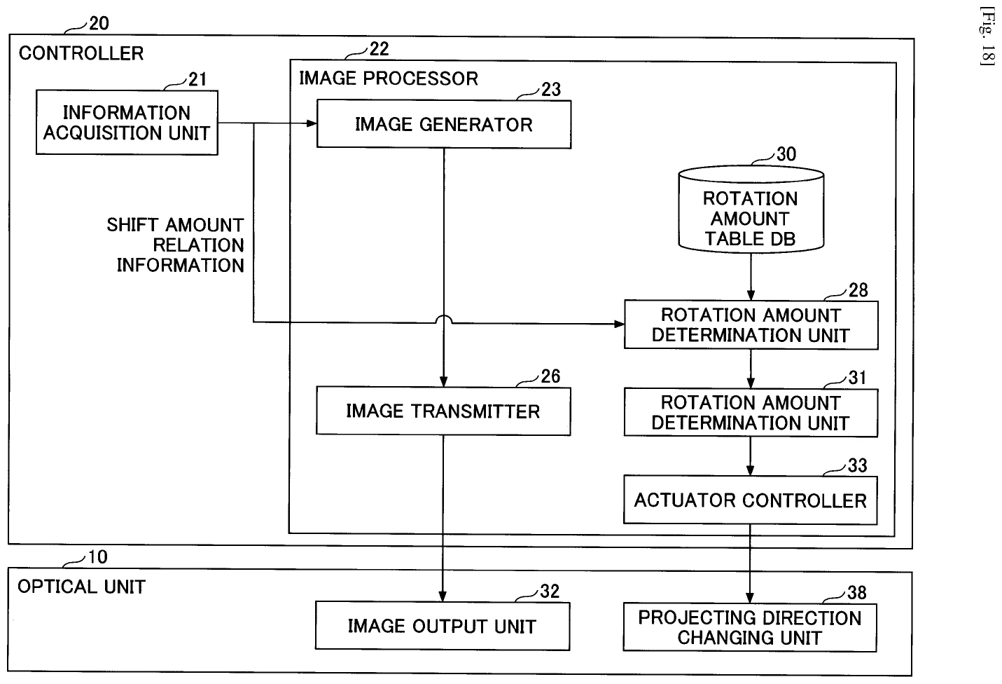

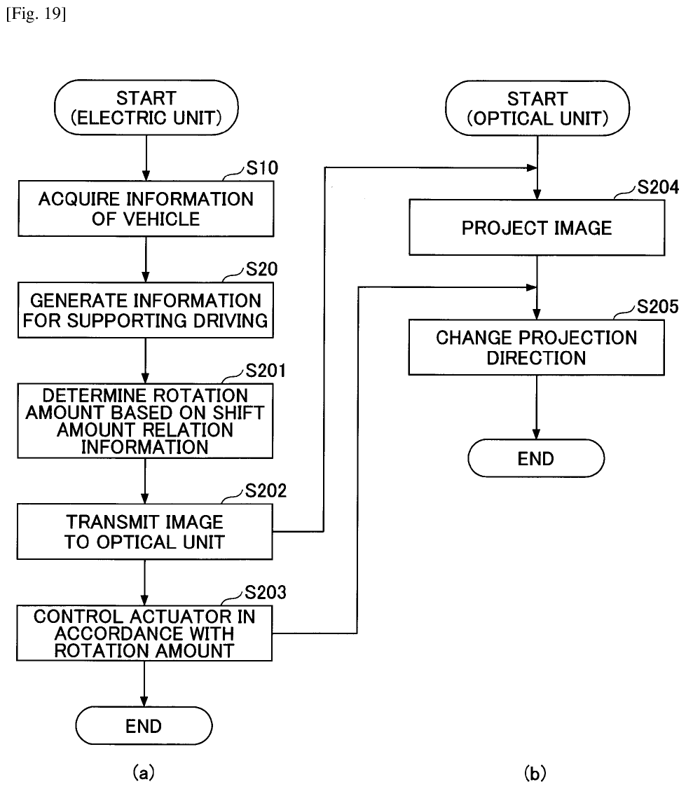

FIG. 19 is a flowchart illustrating an example of a procedure in which the HUD device 1 displays an image so as to be visually perceived by a driver through a transparent member. (a) in FIG. 19 illustrates a process of the controller 20, and (b) in FIG. 19 illustrates a process of the optical unit 10. In the description of FIG. 19, mainly the difference from FIG. 11 will be illustrated. First, the processes in steps S10 and S20 are the same as those in steps S10 and S20 in FIG. 11.

In step S201, the rotation amount determination unit 28 refers to the rotation amount table based on the shift amount relation information, and determines the rotation amount of the actuator 107 or the deflection amount of the optical deflector 102 (S201). That is, the rotation amount determination unit 28 determines how much the actuator 107 is to be rotated or the light deflection direction of the light deflector 102 is to be deflected.

Next, the image transmitter 26 transmits the image to the optical unit 10 (S202). Further, the rotation amount instruction unit 31 indicates, to the actuator controller 33, the rotation amount. The actuator controller 33 controls the actuator 107 in accordance with the indicated rotation amount (S203). Note that steps S202 and S203 are executed in any order, and may preferably be executed in parallel.

Next, the process of the optical unit 10 in (b) of FIG. 19 is illustrated. The image output unit 32 of the optical unit 10 receives an image and outputs a laser beam to display a virtual image I (S204).

The projection direction changing unit 38 changes a projection direction of the image by rotating the actuator 107 under the control of the actuator controller 33 (S205). Alternatively, the projection direction changing unit 38 controls the deflection amount when the optical deflector 102 deflects the light. Note that steps S204 and S205 are executed in any order, and may preferably be executed in parallel.

Thus, when the orientation of the vehicle 9 changes from straight travel to turning traveling, the optical unit 10 shifts an image based on the orientation of the vehicle 9. As a result, the HUD device 1 is enabled to display the virtual image I with a less apparent floating feeling.

Overview

As described above, in the HUD device 1 according to the third embodiment, the optical unit 10 changes the reflection direction of the laser beam by the optical deflector 102 or the concave mirror 105; hence, it is possible to reduce the floating feeling sensed by the driver.

Note that the virtual image I may also be made undisplayed in the third embodiment. For example, the HUD device 1 may stop the light source unit 101 of the optical unit 10 to output a laser beam. Alternatively, the optical deflector 102 deflects the laser beam out of the range of the windshield 91, or the concave mirror 105 reflects the laser beam out of the range of the windshield 91.

### Fourth Embodiment

In the first to third embodiments, the position in the horizontal direction of the virtual image I displayed in front of the vehicle 9 is changed, thereby reducing the floating feeling. However, even when the horizontal direction of the virtual image I displayed in front of the vehicle 9 is changed in accordance with the roll or pitch of the vehicle 9, a deviation between the orientation (rotation) or direction of the image determined by the orientation of the vehicle 9 and the direction of the driver's line of sight may still occur in some cases; as a result, a driver may still sense a floating feeling.

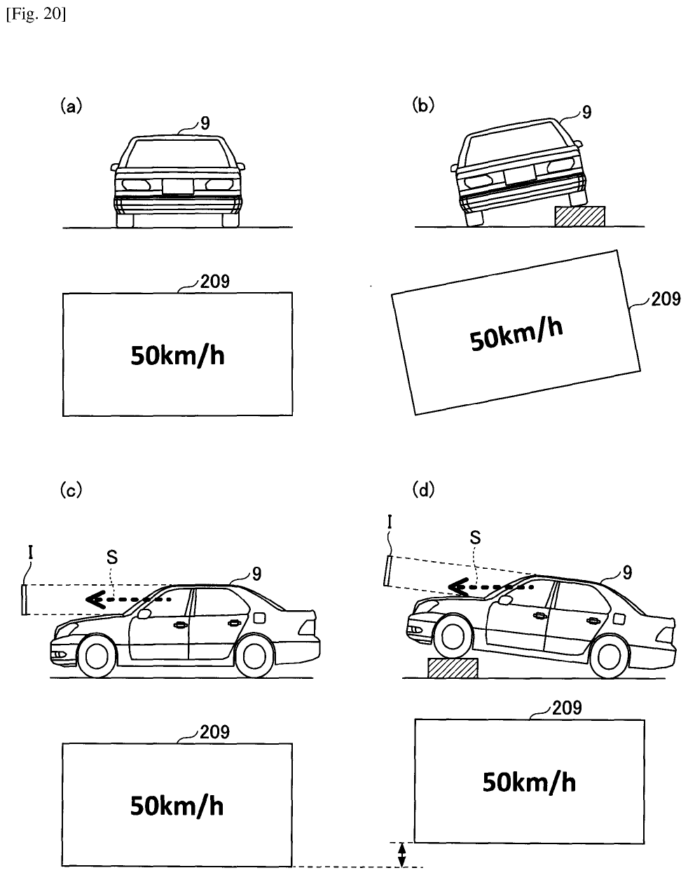

FIGS. 20A to 20D are diagrams illustrating examples of the deviation between the orientation (rotation) or direction of the image determined by the roll or pitch of the vehicle 9 and the direction of the driver's line of sight. (a) in FIG. 20 is a rear view of the vehicle 9. Since the vehicle body is horizontal, the virtual image I is displayed horizontally. (b) in FIG. 20 is a rear view of the vehicle 9; however, since the right wheels of the vehicle 9 ride on a curbstone, the vehicle body is tilted to the left. That is, the roll angle of the vehicle is changed. In this case, the virtual image I displayed by the HUD device 1 fixed to the vehicle body is tilted (inclined) in the same manner; however, the driver V tends to maintain his or her body horizontally, such that the line of sight direction does not rotate as much as the rotation of the virtual image I. As a result, a deviation occurs between a rotation angle of the virtual image I and a rotation angle of the line of sight direction, and a driver may sense a floating feeling.

(c) in FIG. 20 is a side view of the vehicle 9. Since the vehicle body is horizontal, the virtual image I is displayed horizontally. (d) in FIG. 20 is a side view of the vehicle 9; however, since the front wheels of the vehicle 9 ride on a curbstone, the vehicle body is tilted with respect to the front-rear axis. That is, the pitch angle is changed. In this case, the virtual image I displayed by the HUD device 1 fixed to the vehicle body moves upward; however, since the driver V closely views at the traveling direction of the vehicle 9, a line of sight direction S of the driver V does not move upward as much as the display position of the virtual image I. As a result, a deviation occurs between the display position of the virtual image I and the line of sight direction S, and the driver may sense a floating feeling.

The following describes a HUD device 1 according to a fourth embodiment, which reduces a deviation between the display position or the display angle of the virtual image I and the line of sight direction when the orientation of the vehicle 9 changes due to the roll motion or the pitch motion of the vehicle 9, thereby reducing the floating feeling sensed by the driver.

Note that it is presumed that the roll angle during straight traveling is determined as a reference and the vehicle body is horizontal during straight traveling. The horizontal reference of the display position in the roll direction includes, but is not limited to, the earth's horizontal line, the road on which the vehicle 9 is traveling, and a posture of the human head or body.

Functions of HUD Device 1

FIG. 21 is a functional block diagram illustrating examples of functions of the HUD device 1 according to the fourth embodiment. In the description of FIG. 21, mainly the difference from FIG. 7 will be illustrated. The function of the information acquisition unit 21 may be the same as that of the first or second embodiment; however, the information acquisition unit 21 may acquire not only the shift amount relation information but may also acquire the rotation amount relation information and the vertical shift amount relation information from the vehicle 9 or the HUD device 1, and transmit the acquired information to the image processor 22. The rotation amount relation information is information on the roll angle, and the vertical shift amount relation information is information on the pitch angle.

Information on the roll angle is detected from a gyro sensor 16 installed on the vehicle or included in the HUD device 1. In addition to such information, the controller 20 may analyze vehicle height information detected by a vehicle height sensor 14 installed near each wheel, presence or absence of an occupant by a seating sensor 13 installed on each seat in the vehicle (using weight if possible), and the like to calculate the roll angle. Information on the pitch angle is detected from the gyro sensor 16 installed on the vehicle or included in the HUD device 1. Similarly, the controller 20 may also use signals from the vehicle height sensor 14 or the seating sensor 13 to calculate the roll angle.

The image processor 22 of the fourth embodiment includes an image generator 23, a shift amount determination unit 24, an image shift unit 25, and an image transmitter 26. These functions may be the same as those in the first or second embodiment. The image processor 22 also includes a rotation angle table DB 38 for storing the rotation angle table and a vertical shift amount table DB 39 for storing the vertical shift amount table.

TABLE 2

| ROLL ANGLE | ROTATION ANGLE |
|---|---|
| (DEGREES) | (DEGREES) |
| 1 | −1 |
| 2 | −2 |
| 3 | −3 |
| . . . | . . . |

Table 2 indicates a rotation angle table. In the rotation angle table, a roll angle is registered in association with a rotation angle of an image in the image memory 209. For example, the rotation angle table registers that an image in the image memory 209 is rotated by −1 degree when the steering angle is 1 degree. Thus, the rotation angle is the same angle in the direction opposite to the roll angle. The rotation angle of the image is obtained by reversing the sign of the roll angle; hence, the rotation angle table is not required. Note that the plus direction and the minus direction for each of the roll angle and the rotation angle are determined in advance.

TABLE 3

| PITCH ANGLE | VERTICAL SHIFT AMOUNT |
|---|---|
| (DEGREES) | (PIXELS) |
| 1 | Nud1 |
| 2 | Nud2 |
| 3 | Nud3 |
| . . . | . . . |

Table 3 indicates a vertical shift amount table. In the vertical shift amount table, the pitch angle is registered in association with the vertical shift amount. For example, the vertical shift amount table registers that an image in the image memory 209 is shifted upward (or downward) by Nud 1 pixel when the pitch angle is 1 degree. Note that positive and negative directions for the pitch angle are determined in advance on the basis of the horizontal state of the vehicle body; hence, the vertical shift amount of the vertical shift amount table also has a plus or minus sign depending on the pitch angle. Further, the vertical shift amount may be specified by the number of pixels, the length, or the like.

The amount of the deviation between the direction of the image determined by the direction of the vehicle body and the line of sight of the driver V, which gives a sense of floating feeling to the driver V, increases as the distance L at which the virtual image I is formed increases. Hence, the vertical shift amount of the vertical shift amount table may be calculated based on the pitch angle and the distance L. In addition to the calculation, the developers of the HUD device 1 or the like may experimentally determine the vertical shift amount that the driver V less senses floating feeling.

The following describes by referring back to FIG. 21. The shift amount determination unit 24 includes a rotation angle determination unit 34 and a vertical shift amount determination unit 35. The rotation angle determination unit 34 determines, based on the roll angle, the rotation angle of an image in the image memory 209 with reference to the rotation angle table stored in the rotation angle table DB 38. The vertical shift amount determination unit 35 determines, based on the pitch angle, the vertical shift amount of an image in the image memory 209 with reference to the vertical shift amount table stored in the vertical shift amount table DB 39.

The image shift unit 25 has an image rotation unit 36 and an image vertical shift unit 37. The image rotation unit 36 rotates an image formed in the image memory 209 around the center of the image memory 209 with the rotation angle determined by the rotation angle determination unit 34. To rotate an image, an affine transformation or the like may be used. The image vertical shift unit 37 shifts an image formed in the image memory 209 upward or downward by the vertical shift amount determined by the vertical shift amount determination unit 35. The shifting method in the vertical direction may be the same as the shifting method in the horizontal direction described in the first embodiment.

Operation Procedure

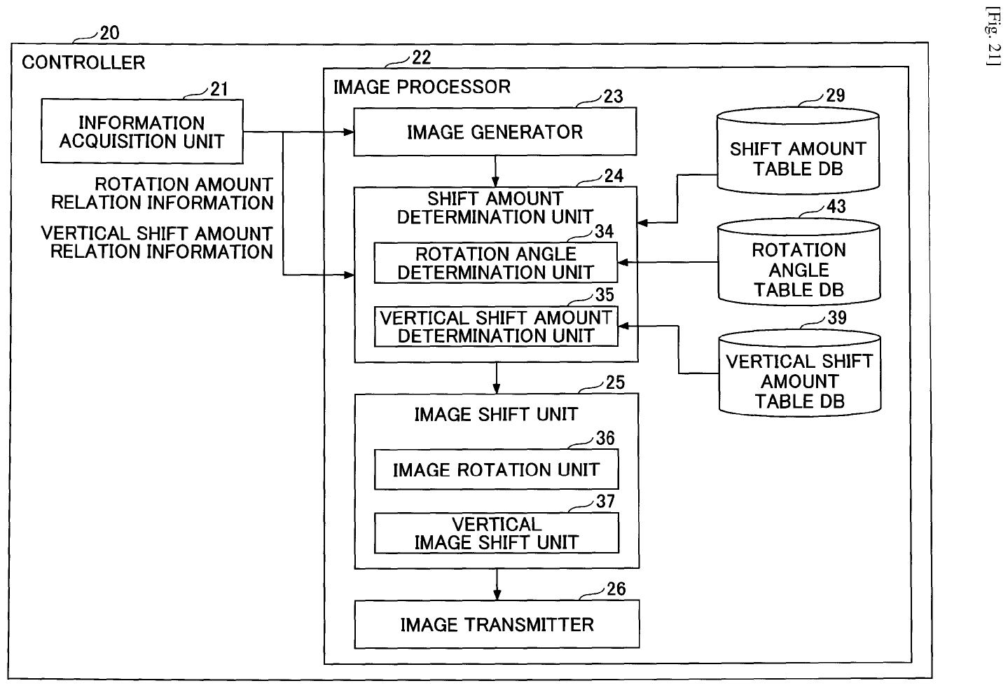

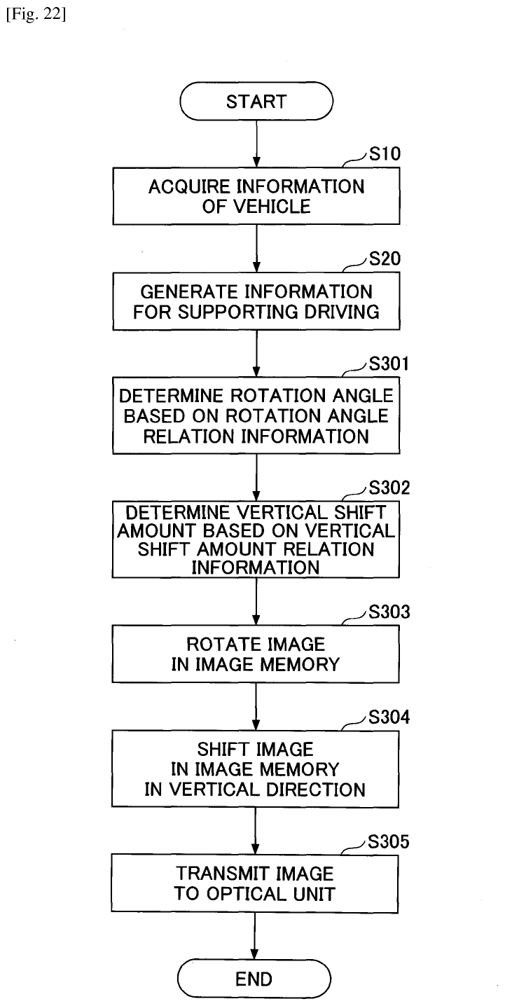

FIG. 22 is a flowchart illustrating an example of a procedure in which the HUD device 1 displays an image so as to be visually perceived by a driver through a transparent member. In the description of FIG. 22, mainly the difference from FIG. 11 will be illustrated. The processes in steps S10 and S20 may be the same as those in steps S10 and S20 in FIG. 11.

Next, the rotation angle determination unit 34 determines the rotation angle of an image formed in the image memory 209 using the rotation angle relation information included in the information acquired by the information acquisition unit 21 (S301). As described above, the rotation angle relation information is information on the roll angle. As a result, whether to rotate an image to the right or the left (rotation direction) is determined in accordance with the roll angle, and the rotation angle in accordance with the roll angle is also determined.

Next, the vertical shift amount determination unit 35 determines the vertical shift amount of the image formed in the image memory 209 using the vertical shift amount relation information included in the information acquired by the information acquisition unit 21 (S302). As described above, the vertical shift amount relation information is information on the pitch angle. As a result, whether to shift toward the upward direction or the downward direction (shift direction in the vertical direction) is determined in accordance with the pitch angle, and the shift amount in accordance with the pitch angle is also determined.

The image rotation unit 36 rotates the image in the image memory 209 by the rotation angle in the rotation direction determined by the rotation angle determination unit 34 (S303).

The image vertical shift unit 37 shifts the image in the image memory 209 by the vertical shift amount in the upward direction or the downward direction determined by the vertical shift amount determination unit 35 (S304). The image transmitter 26 transmits the image toward the optical unit 10 (S305).

As described above, when the vehicle 9 performs a roll motion or a pitch motion, the image is rotated or shifted based on the orientation of the vehicle 9; thus, the HUD device 1 is enabled to display the virtual image I with a less floating appearance.

Note that the pitch angle also changes when the vehicle 9 travels on a slope, and the vehicle 9 traveling on the slope projects a virtual image parallel to the road surface. Further, since the line of sight direction of the driver V (i.e., the vehicle 9) traveling on the slope is parallel to the road surface, a deviation between the projected direction of the virtual image and the line of sight direction hardly occurs (floating feeling hardly appears). Therefore, when the vehicle 9 travels on a slope, it is also effective to perform control not to perform the processing of FIG. 22, or to perform control the processing of FIG. 22 only immediately after entering the slope. Note that traveling on a slope may be determined from the fact that a non-zero pitch angle continues for a certain period of time or may be determined from information on a road map or the like.

Examples of Image to be Created and Virtual Images

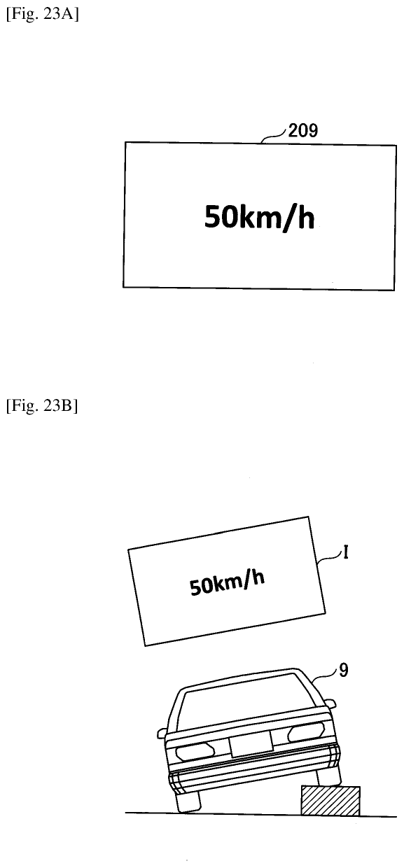

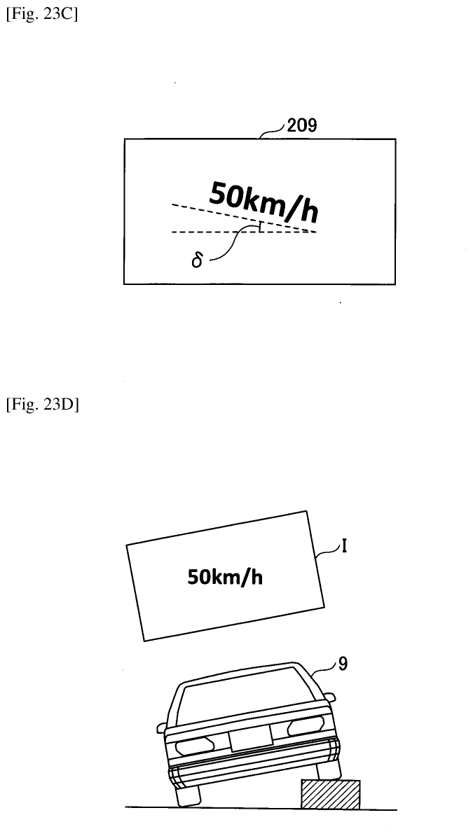

FIGS. 23A to 23D are diagrams schematically illustrating an image generated by the image processor 22 and a virtual image I to be projected. FIG. 23A is a diagram for comparison illustrating an image in the image memory 209 that is not rotated. In FIG. 23A, the image “50 km/h” is formed at the center of the image memory 209. Accordingly, as illustrated in FIG. 23B, when the vehicle 9 rolls, the virtual image I of “50 km/h” is also rotated by the same amount as the roll angle of the vehicle body, which is displayed at the front of the vehicle body.

FIG. 23C is a diagram illustrating an image in the image memory 209 rotated in accordance with information on the roll angle. The image rotation unit 36 rotates “50 km/h”, which is the image in the image memory 209, by the rotation angle δ determined by the rotation angle relation information and the rotation angle table. As illustrated in FIG. 23D, the virtual image I of “50 km/h” is still displayed horizontally even when the vehicle 9 performs a rolling motion, thereby reducing the floating feeling.

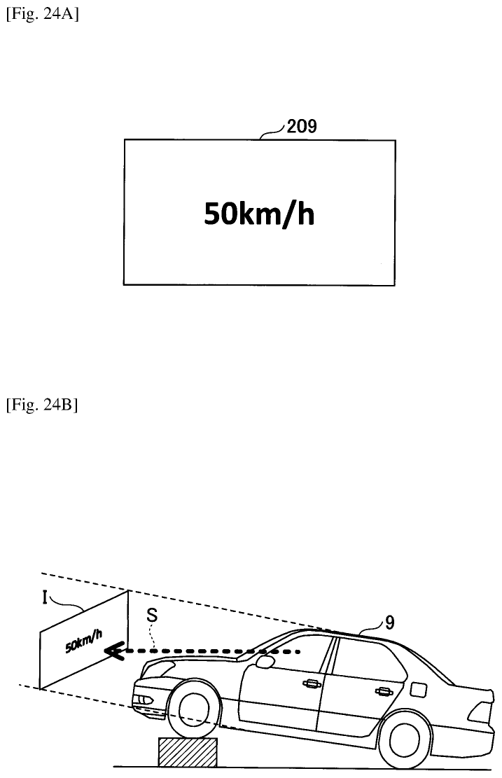

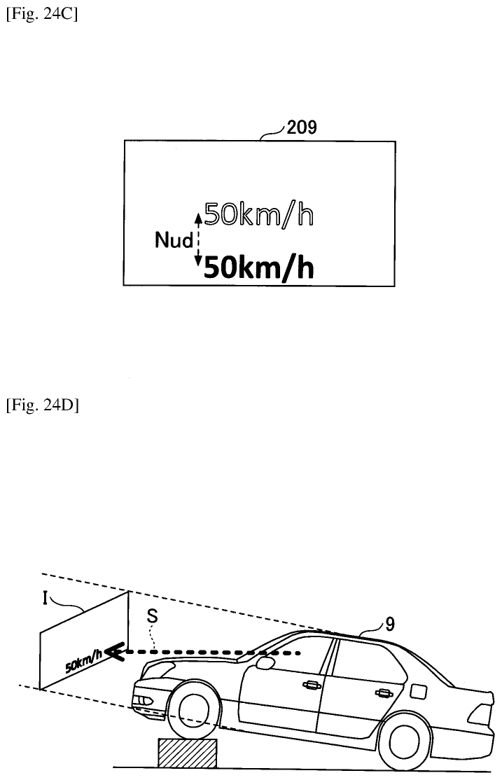

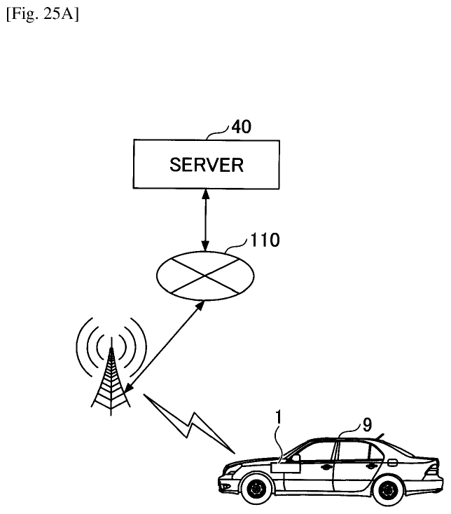

FIGS. 24A to 24D are diagrams schematically illustrating an image generated by the image processor 22 and a virtual image I to be projected. FIG. 24A is a diagram for comparison illustrating an image in the image memory 209 that is not shifted in the vertical direction. In FIG. 24A, the image “50 km/h” is formed at the center of the image memory 209. Therefore, as illustrated in FIG. 24B, when a pitch at which the front side of the vehicle 9 faces upward is made, the virtual image I of “50 km/h” is also displayed above the front of the vehicle body in accordance with the distance L from the vehicle 9 to the virtual image and the pitch angle. As a result, there is a deviation between a driver's line of sight direction S and the display direction of the virtual image I.

FIG. 24C is a diagram illustrating an image in the image memory 209 shifted in accordance with the information on the pitch angle. The image vertical shift unit 37 shifts the image of “50 km/h” in the image memory 209 by the vertical shift amount Nud determined by the vertical shift amount relation information and the vertical shift amount table. As illustrated in FIG. 24D, the virtual image I of “50 km/h” is still displayed in the line of sight direction S of the driver V even if the vehicle 9 performs a pitch motion to make the front face upward; the floating feeling may thus be reduced.

Overview

As described above, the HUD device 1 of the fourth embodiment reduces the rotation of the virtual image I due to rolling of the vehicle body and the vertical shift of the virtual image I due to pitch by rotating the image in the image memory 209 or shifting the image in the image memory 209 in the vertical direction. Accordingly, it is possible to reduce floating feeling sensed by the driver.

Note that in the fourth embodiment, it is also possible to change the vertical position of the virtual image I at the pitch of the vehicle body by controlling the optical deflector 102 or the concave mirror 105. Further, it is possible to rotate the virtual image I at the rolling of the vehicle body by controlling the optical deflector 102 or the concave mirror 105.

Further, when the vehicle 9 rolls or pitches, the image in the image memory 209 (projected) may be thinned, and its luminance or size may be reduced. Alternatively, an image in the image memory 209 may be created with a font having a long vertical dimension of each character.

Further, when the vehicle 9 rolls or pitches, the virtual image I may be made to non-display by deleting the image in the image memory 209, or by not outputting the image by the HUD device 1.

### Other Preferred Embodiments

Although the best modes for carrying out the present invention have been described above by way of embodiments, the present invention is not limited to these embodiments and various modifications and substitution may be made without departing from the spirit of the present invention.

For example, in the above-described embodiments, the controller 20 of the vehicle processes images, but the processes performed by the controller 20 may be performed by another device installed on the vehicle.

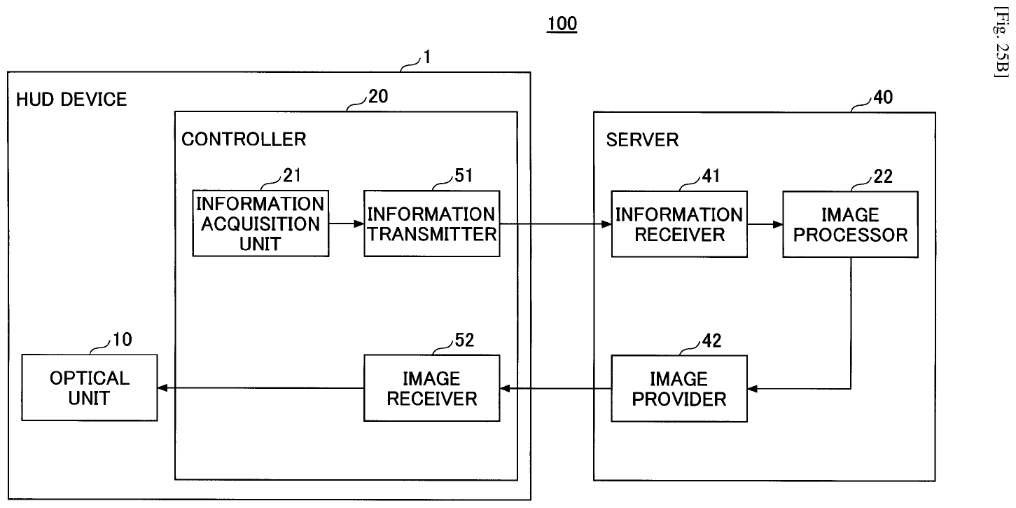

As illustrated in FIGS. 25A and 25B, a server 40 communicably connected to the vehicle 9 via the network 110 may perform image processing according to this embodiment. FIG. 25A is a diagram illustrating a configuration example of a system 100 having a HUD device 1 and a server 40 configured to generate an image for reducing floating feeling. Although the HUD device 1 is installed on the vehicle 9, the server 40 has the function of the image processor 22.

FIG. 25B is a functional block diagram illustrating functions of the HUD device 1 and the server 40. The controller 20 of the HUD device 1 includes an information acquisition unit 21, an information transmitter 51, and an image receiver 52. In addition, the server 40 has an information receiver 41, an image processor 22, and an image provider 42.

With such a configuration, the information transmitter 51 transmits the above information on the vehicle 9 acquired by the information acquisition unit 21 to the server 40. The information receiver 41 of the server 40 receives information on the vehicle 9 and transmits the received information to the image processor 22. The image processor 22 performs the processes described in the first to third embodiments on the server side. The image provider 42 transmits the shifted image or the like to the HUD device 1. The image receiver 52 of the HUD device 1 receives the shifted image and transmits the received shifted image to the optical unit 10. Therefore, when a process is allowed to have a delay in time, the server 40 performs such a process and the HUD device 1 is enabled to display the image received from the server 40.

Further, a virtual image I that has been blur-corrected may be displayed, or a virtual image I may be displayed along the lane.

Note that the image generator 23 is an example of an image generator, the information acquisition unit 21 is an example of an orientation information acquisition unit, at least one of the image shift unit 25, the determination unit 27, the rotation amount determination unit 28, the image rotation unit 36, and the image vertical shift unit 37 is an example of a display change processor, the optical unit 10 is an example of an output unit, and the shift amount relation information is an example of information on traveling on a turning course.

### REFERENCE SIGNS LIST

1 HUD device
9 vehicle
10 optical unit
20 controller
21 information acquisition unit
22 image processor
23 image generator
24 shift amount determination unit
25 image shift unit
26 image transmitter
27 determination unit
27a deletion unit

The present application is based on and claims priority to Japanese Patent Application No. 2017-199914 filed on Oct. 13, 2017, and Japanese Patent Application No. 2018-187737 filed on Oct. 2, 2018, the entire contents of which are hereby incorporated herein by reference.

1-15. (canceled)

16. A display device for displaying a virtual image so as to be visually perceived by an occupant of a moving body through a transparent member, the display device comprising:
an image generator configured to generate an image to be displayed as a virtual image;
an orientation information acquisition unit configured to acquire information on an orientation of the moving body; and
a display change processor configured to change the display of the virtual image in accordance with the information on the orientation acquired by the orientation information acquisition unit.

17. The display device according to claim 16, wherein the display change processor performs a process of changing a display of the virtual image on the image generated by the image generator such that a difference between the virtual image appearing in a first display mode and the virtual image appearing in a second display mode is unnoticeable by the occupant of the moving body, as the change of the display of the virtual image, the first display mode of the virtual image being determined by the orientation of the moving body, and the second display mode of the virtual image being obtained when an instantaneous traveling direction of the moving body is a direction of the moving body.

18. The display device according to claim 16, wherein the display change processor performs a process of changing a display position on the image generated by the image generator, as the change of the display of the virtual image.

19. The display device according to claim 17, wherein the display change processor performs a process of changing a display angle on the image generated by the image generator, as the change of the display of the virtual image.

20. The display device according to claim 16, further comprising an optical unit, wherein
the orientation information acquisition unit acquires information on traveling on a turning course of the moving body as the information on the orientation of the moving body, and the display change processor performs a process of horizontally shifting the image generated by the image generator or the optical unit changes a direction in which the image is projected, based on the information on the traveling on a turning course.

21. The display device according to claim 16, wherein
the orientation information acquisition unit acquires information on a pitch motion of the moving body as the information on the orientation of the moving body, and
the display change processor performs a process of horizontally shifting the image generated by the image generator or the optical unit changes a direction in which the image is projected, based on the information on the pitch motion.

22. The display device according to claim 16, wherein the orientation information acquisition unit acquires information on a roll angle of the moving body as the information on the orientation of the moving body, and
the display change processor performs a process of rolling the image generated by the image generator or the optical unit changes a direction in which the image is projected, based on the information on the roll angle.

23. The display device according to claim 17, wherein
the display change processor makes the image generated by the image generator undisplayed, as a process of reducing a difference between a display position of the virtual image determined by the orientation of the moving body and a display position of the virtual image viewed by the occupant of the moving body.

24. The display device according to claim 16, wherein
the orientation information acquisition unit acquires information on traveling on a turning course of the moving body as the information on the orientation of the moving body, and the display change processor performs a process of thinning the image generated by the image generator, lowering luminance of the image, reducing a size of the image or increasing a width of the image, based on the information on the traveling on a turning course.

25. The display device according to claim 16, wherein
the orientation information acquisition unit acquires information on a pitch motion of the moving body as the information on the orientation of the moving body, and
the display change processor performs a process of thinning the image generated by the image generator, lowering luminance of the image, reducing a size of the image or increasing a width of the image, based on the information on the pitch motion.

26. The display device according to claim 16, wherein the image generator generates an image larger than a virtual image that is visually perceived through the transparent member.

27. A non-transitory computer-readable medium storing a program that when executed causes a display device to function as specified components, the display device being installed on a moving body and being configured to display a virtual image so as to be visually perceived by an occupant of a moving body through a transparent member, the specified components comprising:
an image generator configured to generate an image to be projected as a virtual image;
an orientation information acquisition unit configured to acquire information on an orientation of the moving body; and
a display change processor configured to change the display of the virtual image in accordance with the information on the orientation acquired by the orientation information acquisition unit.

28. An image processing method performed by a display device, for the display device being installed on a moving body, the display device being configured to display a virtual image so as to be visually perceived by an occupant of a moving body through a transparent member, the image processing method comprising:
generating, by an image generator, an image to be projected as a virtual image;
acquiring, by an orientation information acquisition unit, information on an orientation of the moving body; and
changing, by a display change processor, the display of the virtual image in accordance with the information on the orientation acquired by the orientation information acquisition unit.

29. A display system for displaying a virtual image so as to be visually perceived by an occupant of a moving body through a transparent member, the display system comprising:
an image generator configured to generate an image to be displayed as a virtual image;
an orientation information acquisition unit configured to acquire information on an orientation of a mobile body; and
a display change processor configured to change the display of the virtual image in accordance with the information on the orientation acquired by the orientation information acquisition unit.

30. A moving body, comprising:
a transparent member; and
the display system according to claim 29.
